(19) United States
(12) Patent Application Publication
(10) Pub. No.: US 2014/0089157 A1
(43) Pub. Date: Mar. 27, 2014

(54) SYSTEM FOR IMPLEMENTING A COMMODITY ISSUER RIGHTS MANAGEMENT PROCESS OVER A DISTRIBUTED COMMUNICATIONS NETWORK DEPLOYED IN A FINANCIAL MARKETPLACE

(71) Applicant: Joseph H. Hardison, III, Darien, CT (US)

(72) Inventor: Joseph H. Hardison, III, Darien, CT (US)

(73) Assignee: Interest Capturing Systems, LLC, Darien, CT (US)

(21) Appl. No.: 13/627,146

(22) Filed: Sep. 26, 2012

(51) Int. Cl. G06Q 40/04

(52) U.S. Cl. CPC G06Q 40/04
USPC 705/37

(57) ABSTRACT

A computer-network implemented system recognizes that (i) a commodity owner/producer retains (i.e. withholds) the right to lend a commodity prior to the sale/production of a commodity and, (ii) the system allows commodity borrowers to purchase or lease from the commodity owners/producers, through the system, the right to borrow the non-borrowable commodity from the commodity owner/producer, according to sale or lease rates and other terms established by the commodity owner/producer with the system, so that (iii) commodity borrowers can then acquire the right to lend the non-borrowable commodity from the commodity owner/producer and, thereafter, (iv) commodity borrowers can sell the non-borrowable commodity short in the commodity/financial marketplace and profit from a short sale, without adversely effecting the commodity owner/producer.

### RELATED CASES

The present application is a Continuation-in-Part of co-pending application Ser. No. 13/492,886 filed Jun. 10, 2012, which is a Continuation of application Ser. No. 12/465,135 filed Jun. 11, 2009, now U.S. Pat. No. 8,255,296 and commonly owned by Interest Capturing Systems, LLC, and incorporated herein by reference as if set forth in its entirety.

### BACKGROUND OF INVENTION

1. Technical Field

The present invention relates to a method of, and system for, enabling owners/producers of commodities to exercise the rights they possess as the initial owners/producers of commodities in order to manage and optimize the utility and value of their offerings and holdings in the global financial marketplace.

2. Brief Description of the Prior Art

In conventional commodities production/growth, as set forth in FIG. 1 of the Drawings, the commodity owner/producer first produces (mines, drills, grows or otherwise produces) a commodity product—examples would include crude oil, natural gas, gold, corn, wheat and all other commodities—and then, ultimately, sends that product to a market where that product is exchanged for cash or credit, thus completing the production cycle for the commodity producer. During the production cycle, which varies based on the commodity, the owner/producer may enlist various physical product or derivative hedging strategies to lock-in a sales price and/or to protect against downswings and volatility in the price of the commodity. However, once the commodity product has been sold at the end of the production cycle, the original owner/producer loses all control over the sold commodity, and other market participants may benefit by driving the price of the commodity lower, or other factors, like weather, international conflicts, transportation issues/costs, organized labor strikes and other actions and events may also have a detrimental impact on a commodity's price post-sale, which can still hurt the original owner/producer of the commodity, as future commodity production/growth may be affected, in many ways, by the market price of the commodity.

A commodity owner/producer may utilize various derivative contracts and strategies to help protect against future downswings caused by market participants or the aforementioned other factors, but these can be expensive and can leave an owner/producer exposed to financial loss if these contracts move against the owner/producer, and if, for any reason, the owner/producer cannot deliver enough of the specified commodity to meet contractual obligations.

One of the problems that owners/producers of commodities encounter is that of short-selling, through which, investors and speculators borrow a commodity from other market participants, often through the use of futures contracts or other derivative financial instruments, and sell the commodity short in the market hoping to buy it back at a lower price and make a profit. These shorts sales are often highly-leveraged, and short-selling puts downward price pressure on the commodity, which can have several harmful effects. First, as the price of the commodity falls, it can force owners/producers to sell the commodity at disadvantageous prices in order to avoid additional losses if the commodity continues to fall in price, which then adds to the selling pressure on the commodity and drives its price lower. Lower commodity prices hurt the owners/producers and can lead, ultimately, to less production of the commodity and higher prices as there is less production to meet market demand. As commodity owners/producers often rely on borrowing to fund their production, lower commodity prices can, in extreme circumstances, lead to financial ruin for the commodity owners/producers.

However, short-selling has several useful functions. It allows owners/producers of a commodity to hedge their exposure by having an offsetting position in either the underlying commodity or derivative instrument linked to the commodity. In the event the hedge is in the form of a derivative instrument, the seller of that derivative instrument usually has to sell short the commodity in order to hedge its downside exposure. Short-selling is also employed by speculators (hedge funds, bank trading desks, individuals, etc.) to make a direct bet against the price of a commodity.

The advent of more sophisticated derivative instruments and commodity-based, highly-levered exchange-traded funds (ETF's), along with the proliferation of hedge funds and other speculative interests, have combined to allow speculators and hedgers to put unwarranted, and often intentional, selling pressure on a commodity. A good example of this problem in practice is the current price pressure on natural gas in the United States, which has forced many owners/producers to cap existing natural gas wells and delay future production due to the low prices of natural gas which, in part, have been caused by speculation and short selling of natural gas. As many of the large natural gas producers have borrowed heavily to finance their drilling and exploration activities, these low prices imperil many of them.

Another problem is that the further the price of a commodity is depressed by short-selling, the harder, more expensive, and more dilutive it becomes for a commodity owner/producer to raise additional capital through additional debt or equity sales. Excessive selling pressure and the resulting lower commodity price, via short sales and derivative instruments, can influence and/or cause rating agencies to downgrade a commodity owner's/producer's financial ratings, thereby increasing the cost of raising additional capital via debt sales. Similarly, excessive downward pressure, via short sales and derivative instruments, on a commodity owner's/producer's publicly traded stock can depress the stock to extremely low levels making additional equity sales highly dilutive to existing shareholders. In extreme cases, the pressure on a company's stock from a low commodity price can make it virtually impossible to raise new capital via equity sales because of the dilutive effects. Finally, for privately-held commodity owners/producers, downward pressure on their commodity's price can hamper their efforts to obtain bank financing.

Recently, there have been several attempts, all regulatory, to address the problems associated with, and/or caused by, short-selling. The Commodities Futures Trading Commission (CFTC) has imposed several margin requirement increases, in various commodities markets, in order to curtail excessive market speculation. Various other remedies have been proposed that all aim at imposing additional regulatory oversight in the commodity markets and on speculators and investors that participate in these markets/instruments.

As discussed above, short-selling in commodities has become a huge problem in today's capital markets, as it can have a detrimental impact on commodity prices and, thus, on commodity owners/producers. Short selling can increase volatility in a commodity's price, which can force commodity owners/producers to sell their commodities at unfavorable prices to avoid a (further) loss. Every proposal to address the problems associated with short-selling, to date, has been regulatory in nature.

All of following US patents and patent application Publications disclose various systems and methods for recognizing and trading commodities, either on commodity exchanges or physically: U.S. Pat. No. 8,249,975 (Keith), U.S. Pat. No. 8,195,544 (Horsfall), U.S. Pat. No. 8,180,698 (Lerner), U.S. Pat. No. 8,078,523 (Chadid, et al), U.S. Pat. No. 8,015,089 (Baya'a, et al), U.S. Pat. No. 7,991,685 (Tatge, et al), U.S. Pat. No. 7,945,505 (Van Slyke), U.S. Pat. No. 7,904,373 (Kimle, et al), U.S. Pat. No. 7,827,083 (Beurskens) (Reding, et al), U.S. Pat. No. 7,707,086 (Burns, et al), U.S. Pat. No. 7,433,839 (Bodurtha, et al), U.S. Pat. No. 7,319,984 (Frankel, et al), U.S. Pat. No. 7,171,386 (Raykhman), U.S. Pat. No. 7,149,717 (Kan), U.S. Pat. No. 6,907,402 (Khaitan), U.S. Pat. No. 6,868,401 (Carpenter, et al), U.S. Pat. No. 6,493,683 (David, et al), U.S. Pat. No. 5,285,383 (Lindsey, et al), U.S. Pat. No. 4,677,552 (Sibley, Jr.) and U.S. Publication Nos. 20120215678 (Lerner), 20110276458 (Broden, et al), 20110251927 (Gless, II), 20110178953 (Johannes), 20110173114 (Annunziata), 20100121755 (Spurgin, et al), 20100114753 (Osmanski, et al), 20090271328 (Bloom), 20090271298 (Bloom), 20090234768 (Van Slyke), 20090177574 (Tatge), 20080301034 (Reding), 20080208728 (Sugihara), 20070130058 (Beurskens), 20050086153 (Scott), 20020013758 (Khaitan). However, each of these prior art references fails to address, either singularly or in combination with each other, the aforementioned problems associated with short-selling of an owner's/producer's commodity, as each addresses the trading of, or mechanisms associated with the trading of, commodities.

Furthermore, a careful review of US patents (e.g. U.S. Pat. No. 7,428,508 et al) assigned or issued to major financial commodity exchanges reveals that all conventional computer-implemented networks (i.e. commodity exchanges) are based on the assumption that the holder/purchaser of a commodity possesses the right (power and authority) to lend it to whomever, whenever they may decide, regardless of the consequences or impact such commodity lending/short selling might have on the commodity owner/producer or on the marketplace during short-selling.

U.S. Pat. No. 7,742,979 U.S. Publication No. 20050125323 to Warren, U.S. Publication No. 20020198833 to Wohlstadter, U.S. Publication No. 20050080705 to Chaganti, and U.S. Pat. No. 7,310,616 to Sugahara all disclose various methods for recognizing and trading various security rights of issued securities.

In view of all of the aforementioned shortcomings, deficiencies and inefficiencies that exist in the financial/commodity marketplaces, there is a great need in the art for improved systems and methods for solving the problem(s) associated with investors, speculators and/or hedgers putting unwarranted downward pressure on the prices of owners'/producers' commodities through short sales and the use of derivative instruments, while avoiding the shortcomings and drawbacks of the prior art apparatus and methodologies heretofore known.

### OBJECTS AND SUMMARY OF THE PRESENT INVENTION

Accordingly, it is a primary object of the present invention to provide a method of, and system for, solving the inefficiencies of prior art, in the forms of detrimental commodity trading and speculation methods, while avoiding the shortcomings and drawbacks of the prior art apparatus and methodologies.

Another object of the present invention is to provide a market-based solution that allows commodity owners/producers to manage, and to benefit from, short-selling in their commodities.

Another object of the present invention is to provide a radically new computer network-implemented system that provides an effective solution to the problems associated with conventional commodity short-selling practices, by radically departing from deeply accepted conventions in the world of financial engineering.

Another object of the present invention is to provide a computer network-implemented system that allows the commodity owner/producer to retain the right (authority and power) to lend a commodity prior to, and after, sale of the commodity, and allows commodity borrowers to request from the commodity owner/producer, through the system, the right to borrow the “non-borrowable” commodity from the commodity owner/producer for the purpose of selling the “non-borrowable” commodity short in the financial/commodity marketplace and profiting from a short sale, without damaging the commodity owner's/producer's ongoing economic interests.

Another object of the present invention is to provide a computer network-implemented system that allows commodity investors, speculators and hedgers to sell short commodities, with complete anonymity to the commodity owners/producers, while still allowing the commodity owners/producers to benefit and profit from short-selling against their economic interests, thereby benefiting all market participants.

Another object of the present invention is to provide a method and system which inherently recognize the separate, withholdable, and transferable rights associated with commodities, thereby enabling the maximization of economic value that such property can support within the marketplace.

Another object of the present invention is to provide such a method and system, wherein the rights associated with commodities are automatically unbundled (i.e. individually separated) in such form that each individual right, or subsets of individual rights, can be withheld prior sale into a commodity market and then transferred independently of the other commodity rights in an effort to optimize the utility and economic value to the commodity owner/producer.

Another object of the present invention is to provide such a method and system wherein the owners/producers of commodities are afforded the opportunity to freely withhold and transfer certain of the rights they possess as owners/producers of commodities in order to limit certain other activities they may deem detrimental to their interests as commodity owners/producers.

Another object of the present invention is to provide owners/producers of commodities with the ability to prevent speculators and other non-investing entities from selling short an owner's/producer's commodity by allowing the owner/producer of said commodity to withhold the right to lend its commodity, in order to prevent it from being lent to short-sellers to be sold short.

Another object of the present invention is to provide owners/producers of commodities with the ability to prevent investors, speculators and others from using the owners'/producers' commodities as collateral for borrowing, or other trading and investing activities, by allowing the owners/producers of commodities to withhold the right to post those commodities in order to prevent them from being used as collateral for borrowing, trading or investing.

Another object of the present invention is to provide such a method and system, wherein the set of rights associated with commodities {CR (α . . . η, $)} possessed by an owners/producers of commodities, are separate and divisible.

Another object of the present invention is to provide such a method and system, wherein the set of rights possessed owners/producers of commodities can be utilized in non-mutually exclusive manners.

Another object of the present invention is to allow owners/producers of commodities to establish pricing for the withheld commodity rights to lend their equity commodities in order to optimize income associated with leasing or selling the withheld rights to lend their commodities, for the benefit of owners/producers of commodities.

Another object of the present invention is to allow commodity owners/producers to determine how much, if any, of their withheld commodity rights to lend to lease or sell in order to control short-selling of their commodities and to profit from any short-selling of their commodities.

Another object of the present invention is to provide an Internet-based method and system, wherein all participating commodity owners/producers feed all commodity rights information (withheld commodity rights, transferred commodity rights, leased/sold commodity rights, etc.) directly into a database maintained by the system of the invention for the purpose of allowing the Internet-based system to catalogue and display certain commodities' rights information to owners/producers of commodities and/or to potential lessees/buyers of commodity rights.

Another object of the present invention is to provide such an Internet-based method and system, wherein a process is provided to allow the system to rank various commodity rights for a system user's benefit via criteria that may differ vastly from that typically employed by a system user.

Another object of the present invention is to provide such an Internet-based method, whereby institutional users are provided with a manual and/or automatic means for accessing the universe of commodity rights details (e.g. details on individual commodity's rights withholdings, transfers, etc.), thereby ensuring that they fulfill their fiduciary duty to their investors who seek the various qualities/commodities rights in the commodities and commodity rights they purchase, lease, sell and/or hold.

Another object of the present invention is to provide such an Internet-based system, whereby institutional users are provided with a manual and/or automatic means for accessing the universe of commodity rights details (e.g. details on individual commodity's rights withholdings, transfers, etc.), thereby ensuring that they fulfill their fiduciary duty to their investors who seek the various qualities/commodities rights in the commodities and commodity rights they purchase, lease, sell and/or hold.

Another object of the present invention is to provide such an Internet-based method and system, wherein financial institutions and any entity holding a fiduciary responsibility have the ability to fulfill their obligations to their investors by seeking the best commodity right(s) terms, thereby reducing potential legal liability associated with the failure to fulfill attendant fiduciary responsibilities and obligations.

Another object of the present invention is to provide such an Internet-based method and system, wherein a system user would still be able to establish one or more important criteria regarding various commodities' rights and then allow the system to take over and make investment decisions based on the limited criteria provided by a system user.

Another object of the present invention is to provide an Internet-based method and system, wherein commodity owners/producers are able to exact higher remuneration and better terms from banks or financial institutions for commodity rights withheld prior to production and/or sale into a marketplace, mainly the rights to lend the owners'/producers' commodity.

Another object of the present invention is to allow commodity owners/producers to combine various subsets of total set of commodity rights {CR (α . . . η, $)} to allow the commodity owners/producers to maximize the economic benefits of the commodity rights under their control, both prior to and during commodity production/growth, and with any retained commodity right(s) after the commodity has been sold or leased in the global commodity/financial marketplace.

Another object of the present invention is to provide an Internet-based method and system, wherein relational databases automatically receive pricing information from various commodity brokers, banks, and other financial institutions for the owners'/producers' commodities and individual commodity rights and display the information based on absolute rank and, separately, on the system user's and on the system's preferences.

Another object of the present invention is to provide such an Internet-based method and system, wherein government regulatory agencies can actively monitor all commodity right(s) withholdings, transfers, sales, leases, and other related transactions.

Another object of the present invention is to provide an Internet-based method and system for representing and accounting for the commodity rights held by commodity owners/producers, and the transfers (temporary or permanent) of such rights among a network of financial institutions, provided by the Internet-based system and method of the present invention.

Another object of the present invention is to provide a transparent “netting” process through which financial institutions settle withheld/transferred commodity rights amongst themselves.

Another object of the present invention is to provide owners/producers of commodities already produced, but not yet sold into the financial marketplace, with the ability to convert those existing commodities to withhold the right(s) to lend their commodities to preclude short-selling of those commodities already produced. This will allow commodity owners/producers to preclude behavior they deem detrimental to their own interests.

Another object of the present invention is to provide commodity owners/producers with the ability to market various withheld and/or unbundled commodity rights (principally, the right(s) to lend a commodity) in order to control and profit from the unlocked value of those rights. For example, an owner/producer could withhold the right to lend its commodity to short-sellers to preclude short-selling, and the owner/producer could then lease that right to lend its commodity to short-sellers at rates it deems advantageous.

Another object of the present invention is to provide commodity owners/producers with the ability to classify their commodities, of all types, with certain alphanumeric-coded designations to signify that certain commodities cannot be lent, used as collateral, sold, or used in any other way that may contravene the commodity owners'/producers' original, included specifications upon production.

Another object of the present invention is to provide various schedules upon which commodity owners/producers can collect commodity lending income based on production cycles, average length of futures contracts, set time periods, or other metrics, as commodity production, storage and life cycles vary greatly; some schedules may be short-term to reflect consumption after production (grains, livestock, etc.), while some schedules may be much longer in tenure to reflect commodities that can be stored indefinitely (metals, crude oil and refined petroleum products, etc.).

These and other objects of the present invention will become more apparent from the descriptions and drawings contained herein, and are, by no means, confined or limited by other improvements or advantages that may be realized.

### BRIEF DESCRIPTION OF THE DRAWINGS

In order to understand more fully the Objects of the Invention, the following Brief Descriptions of the Illustrative Embodiments should be read in conjunction with the appended figure drawings, wherein:

FIG. 1 is a schematic representation illustrating the flow of commodity production from the production of a commodity by its owner/producer, wherein a commodity owner/producer grows, mines, pumps or otherwise produces a commodity product and distributes the commodity product either to the commodity's specific market or directly to a commodity user, which may use the commodity to manufacture a product, may consume the commodity, or may store the commodity for future usage. Once the commodity owner/producer sells the commodity into the commodity market, various user and investor groups purchase the commodity either for immediate or future use/consumption or to trade the commodity in hope of profiting from movements, up and down, in the commodity's price;

FIG. 2 is a schematic representation of the various rights traditionally possessed by owners and/or holders of commodity owners/producers;

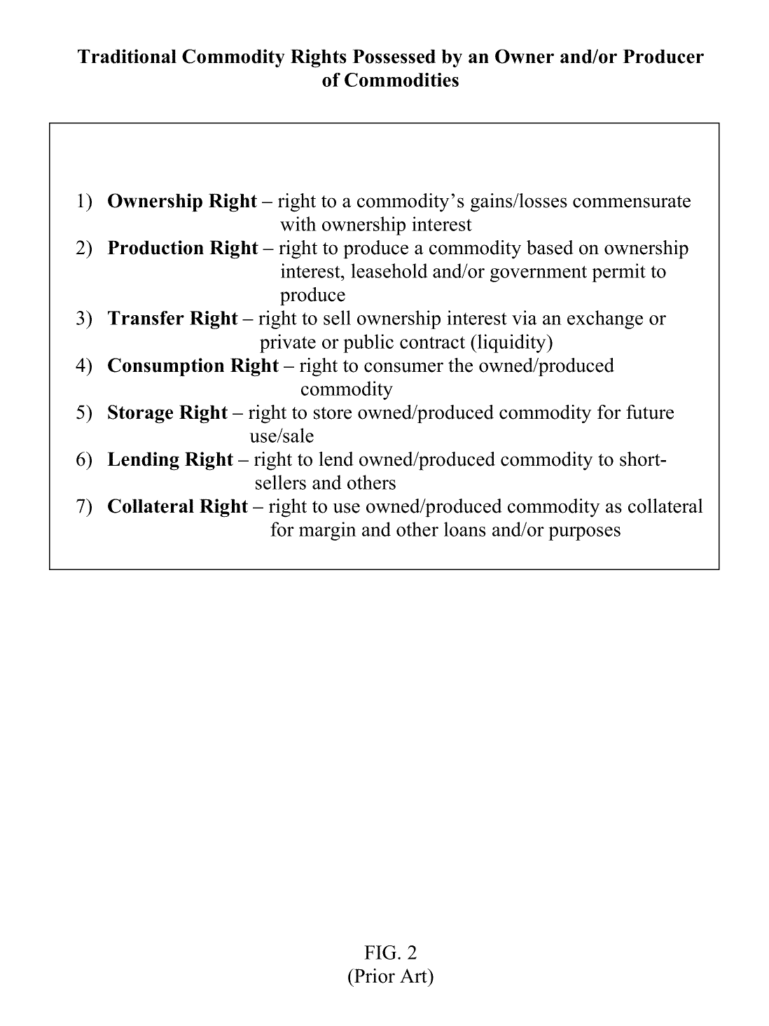

FIG. 3 sets forth a set of equations that formally recognize and describe a broad set of commodity rights (CR (α . . . η, $)) possessed, and grantable, by an owner/producer of a commodity prior to sale into of the commodity into a commodity/financial marketplace, which can be separated and structured into a package of commodity rights to be issued as a commodity rights package to suit perfectly a commodity owner's/producer's needs, and illustrating that, in accordance with the principles of the present invention, this set of individual commodity rights is divisible and combinable, and each individual commodity right is separately able to be withheld, prior to sale of a commodity, or transferred (temporarily or permanently), in a non-mutually exclusive manner, so as to maximize the utility of a commodity to the commodity owner/producer in the global marketplace, in a manner akin to the bundle of rights possessed through ownership of land, including rights pertaining to minerals, timber, agriculture, surface usage, water usage, air usage, and riparian and development rights, to name the most common individual rights associated with owning and/or holding real property;

FIG. 4 is a high-level systems block diagram representation of the Internet-based Commodity Owner/Producer Rights Management (COPRM) Network of the present invention, realized as a carrier-class, globally-extensive packet-switched financial information management and communications network, designed and implemented on a Java-based, object-oriented integrated development environment (IDE) such as, for example, WebObjects 5.2 IDE by Apple Computer Inc, Websphere IDE by IBM, or Weblogic IDE by BEA, or Microsoft® Visual Studio 2005.NET IDE;

FIG. 4A is a schematic representation of a first enterprise-level implementation of the COPRM network of the present invention;

FIG. 4B is a schematic representation of a second enterprise-level implementation of the COPRM network of the present invention;

FIG. 5 is a schematic representation of the commodity rights withholding process of the COPRM network of the present invention carried out on the COPRM network shown in FIG. 4, wherein only the right to lend a commodity (CR (ξ, $)) is withheld and retained by an owner/producer of the commodity prior to its sale into commodity/financial marketplace or its sale to a commodity user/consumer, while the remaining subset of commodity rights is sold or leased to a purchaser/lessee either via a commodity market or directly from the commodity owner/producer; by withholding the commodity right to lend from the newly-formed commodity package of rights, the commodity owner/producer has effectively precluded anyone holding or storing the commodity in the future from lending it to short-sellers for shorting purposes, thereby allowing both the commodity owner/producer and commodity purchasers or lessees to maximize the utility of the commodity in the global marketplace in accordance with principles of the present invention;

FIG. 6A is a schematic representation of the Commodity Owner/Producer Rights Management Process (COPRMP) of the present invention carried out on the COPRM Network shown in FIG. 6A, wherein only the right to lend a commodity (CR (ξ, $)) is withheld and retained by a commodity owner/producer prior to sale or lease into a commodity/financial marketplace, while the remaining subset of commodity rights (CR (α . . . η, $))−(CR (ξ, $))) is sold/leased to a purchaser/lessee either through a commodity/financial marketplace or is sold/leased to a purchaser/lessee directly by the commodity owner/producer, thereby effectively precluding anyone holding the commodity from lending it to short-sellers for short-selling purposes, and allowing both the commodity owner/producer and commodity purchaser/lessee to maximize the utility of the commodity offering in the global marketplace in accordance with principles of the present invention;

FIG. 6B is a schematic representation of the COPRMP of the present invention carried out on the COPRM network shown in FIG. 4, wherein its various components interact so as to enable a commodity owner/producer to withhold, retain, and transfer (temporarily or permanently) the right to lend a commodity (CR (ξ, $)), while retaining the right to withhold one or more commodity rights associated with a commodity, in order to help a commodity owner/producer to achieve its goals with respect to commodity production and sale/lease, and with respect to its ability to control and profit from the retention, and transference of, the withheld commodity right to lend (CR (ξ, $));

FIG. 6C is a flow chart depicting the various steps carried out during the Implementation of the Commodity Owner/Producer Rights Management Process (COPRMP) of the present invention depicted in FIG. 6B illustrating the withholding and retention by a commodity owner/producer, of the commodity right to lend (CR (ξ, $));

FIG. 7 is a schematic representation of a COPRM network of the present invention employing a Non-Borrowable (Non-Shortable) Commodity Exchange and Network of the Present Invention illustrating a process whereby commodity owners/producers that have withheld the commodity right to lend (CR (ξ, $)) from their commodity (denoted by an “L” after the commodity name), make those commodities non-borrowable and, thus, impossible to short-sell by speculators, hedgers and/or investors—the “L” after the commodity name signifies a “long-only” commodity. The “Long-Only Commodity Exchange” functions just like a normal commodity exchange, where buyers buy and sell commodities, and all required transactions are reported to the Commodity Futures Trading Commission and/or to federal and state regulators;

FIG. 7A is a schematic representation of a first enterprise-level implementation of the COPRM network of FIG. 7;

FIG. 7B is a schematic representation of second enterprise-level implementation of the COPRM network of the present invention;

FIG. 7C is a flow chart depicting the various steps carried out on the Non-Borrowable (Non-Shortable) Commodity Exchange and Network of the Present Invention, shown in FIG. 7;

FIG. 8 is a schematic representation of the COPRM network of FIG. 8, supporting the COPRM Network Commodity Conversion Process of the present invention, which allows commodity owners/producers to convert their commodities (owned or produced) into “long-only” commodities by way of separating and withholding the commodity right to lend (CR (ξ, $)), wherein a participating commodity owner/producer utilizes the COPRM system to restructure its owned/produced commodity by withholding the right to lend that commodity, and then sells or leases the new commodity package of rights into the commodity/financial market, with the commodity owner/producer retaining the withheld right to lend its commodity to preclude short-selling;

FIG. 8A is a schematic representation of a first enterprise-level Implementation of the COPRM network of FIG. 8;

FIG. 8B is a schematic representation of a second enterprise-level implementation of the COPRM network of FIG. 8;

FIG. 8C is a flow chart depicting the various steps carried out during the Commodity Conversion Process of the present invention carried out on the COPRM network of FIG. 8;

FIG. 9 is a schematic representation of the COPRM Network of the Present Invention employing a Commodity Owner/Producer-Controlled Commodity Rights Management Exchange according to the present invention, which allows commodity owners/producers to control the selling short of their commodity by determining lease rates, time periods and the amount of total commodity available with the associated leasing of the withheld commodity right to lend (CR (ξ, $)), needed by short-sellers to short the commodity;

FIG. 9A is a schematic representation of a first enterprise-level implementation of the COPRM network of FIG. 9;

FIG. 9B is a schematic representation of a second enterprise-level implementation of the COPRM network of FIG. 9;

FIG. 9C is a flow chart depicting the various steps carried out during the Commodity Owner/Producer-Controlled Commodity Rights Management Exchange Process of the present invention supported on the COPRM network of FIG. 9.

FIG. 10 is a graphical user interface (GUI) screen supporting the COPRM Network Commodity Owner/Producer-Controlled Rights Management Exchange Process for Establishing Commodity Lending Rights Lease Rates that allows a commodity owner/producer to set the borrowing terms for its commodities and, through which, a commodity right(s) lessee selects various accounts and terms both from drop-down menus and by typing in pertinent information related to the leasing of one or more commodity rights (principally the commodity right to lend) from the commodity owner/producer;

FIG. 10A is a flow chart depicting the various steps carried out during the COPRM Network Commodity Owner/Producer-Controlled Rights Management Exchange Process for Establishing Commodity Lending Rights Lease Rates on a graphical user interface (GUI) screen;

FIG. 11 is a COPRM Network Commodity Owner/Producer-Controlled Rights Management Exchange Process for Commodity Lending Rights Lessors graphical user interface (GUI) screen; and

FIG. 11A is a flow chart depicting the various steps carried out during the COPRM Network Commodity Owner/Producer-Controlled Rights Management Exchange Process for Commodity Lending Rights Lessors on a graphical user interface (GUI) screen;

### DETAILED DESCRIPTION OF THE ILLUSTRATIVE EMBODIMENTS OF THE PRESENT INVENTION

Referring to the figures in the accompanying Drawings, the illustrative best mode embodiments of the present invention will now be described in greater technical detail, wherein like parts are indicated by like reference numbers.

### Overview of the Method of Commodity Owner/Producer Rights Withholding and Transfer According to the Principles of the Present Invention

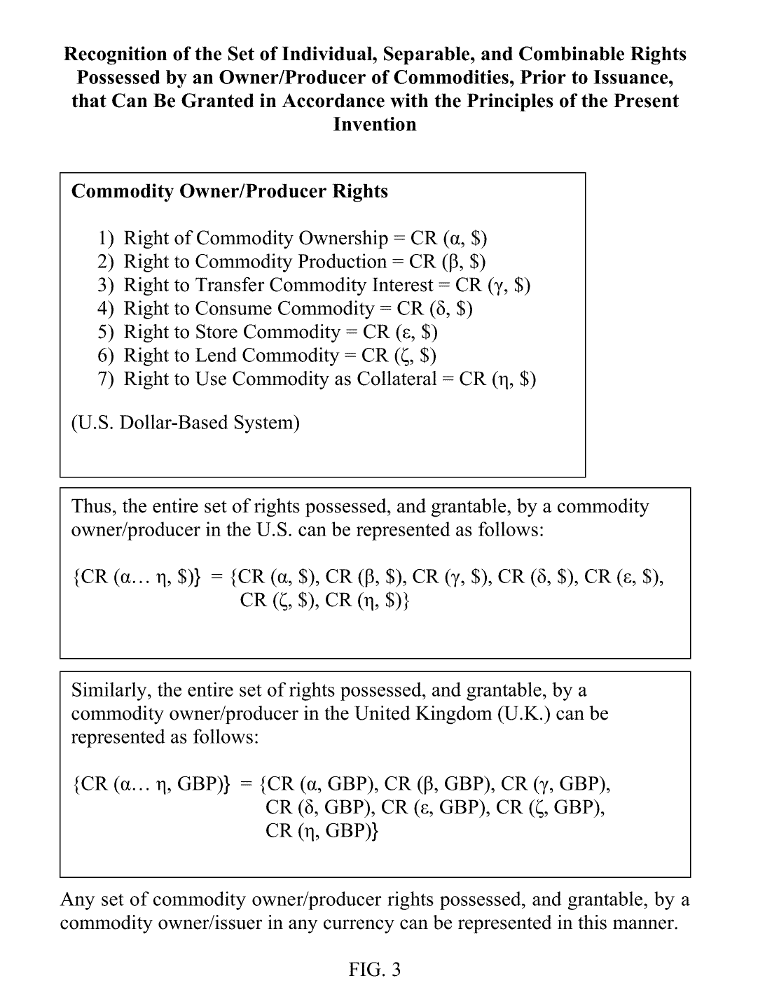

Referring to FIG. 3, there is presented an important set of equations that formally recognizes a broad set of commodity rights, possessed and grantable by an owner/producer of commodities (CR (α . . . η, $)), prior to a commodity's sale or lease into the commodity/financial marketplace. In accordance with the principle of the present invention, this set of commodity rights can be separated and structured into a subset of commodity rights to be issued as a commodity package of rights to more perfectly suit a commodity owner's/producer's needs, thereby allowing certain right(s) to be effectively withheld prior to a commodity's sale (or lease) by an owner/producer or other entity or, which, can be utilized to convert commodities that have already been sold or leased into the global commodity/financial marketplace by the current owner into non-shortable commodities in accordance with the principles of the present invention.

As will be described in greater detail hereinafter, the withholding of such commodity right(s) prior to sale by an owner/producer, or via the conversion process, is carried out using the Commodity owner/Producer Rights Management Process (COPRMP) and system of the present invention, which recognizes and ensures that the above-identified set of individual commodity rights is divisible and combinable prior to a commodity's sale or lease (or post-original sale or lease by the new owner of the commodity), and that the individual right to lend commodities (CR (ξ, $)) is separately withholdable prior to a commodity's sale, enabling a commodity owner/producer to effectively preclude short-selling of its commodity—a process owners/producers have, heretofore, been unable to stop or control to their great detriment.

### Implementation of the Various Embodiments of the COPRMP Information Network of the Present Invention

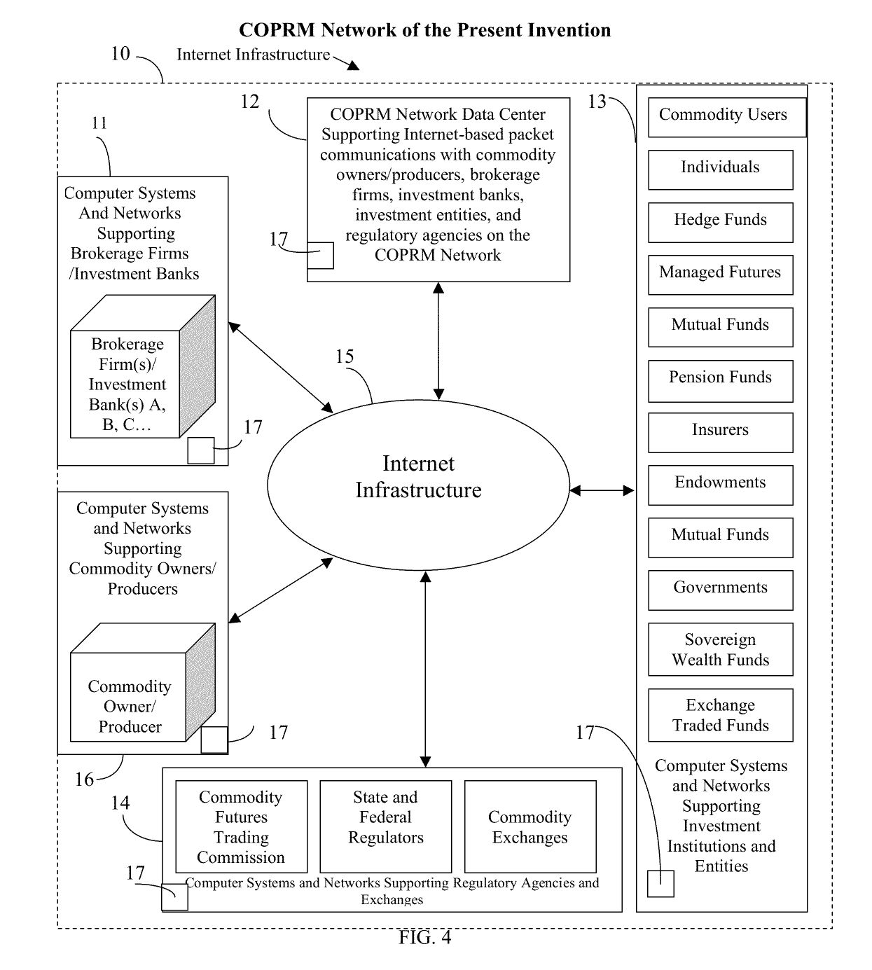

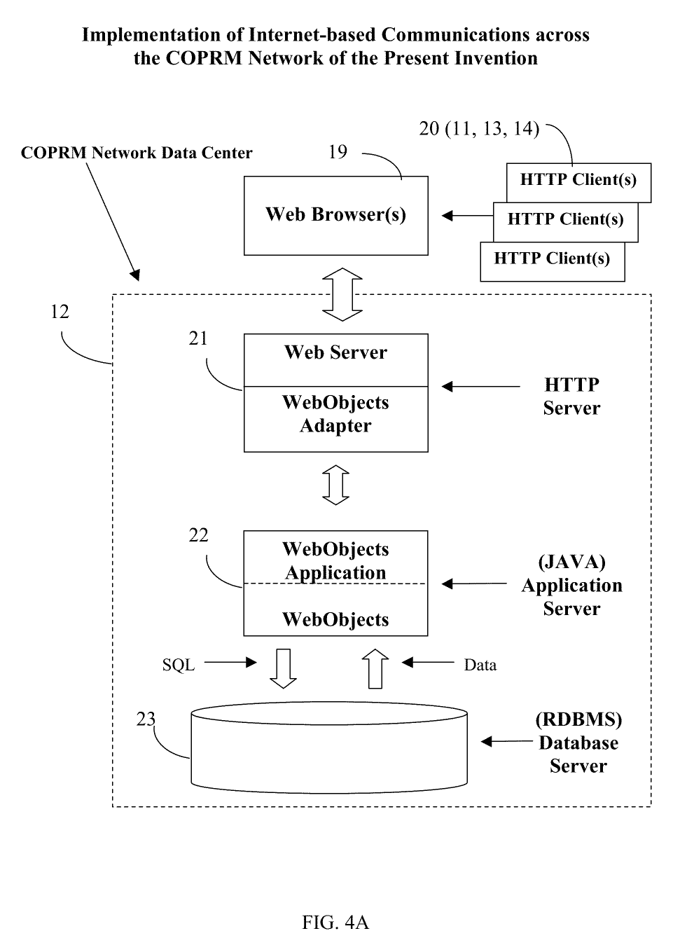

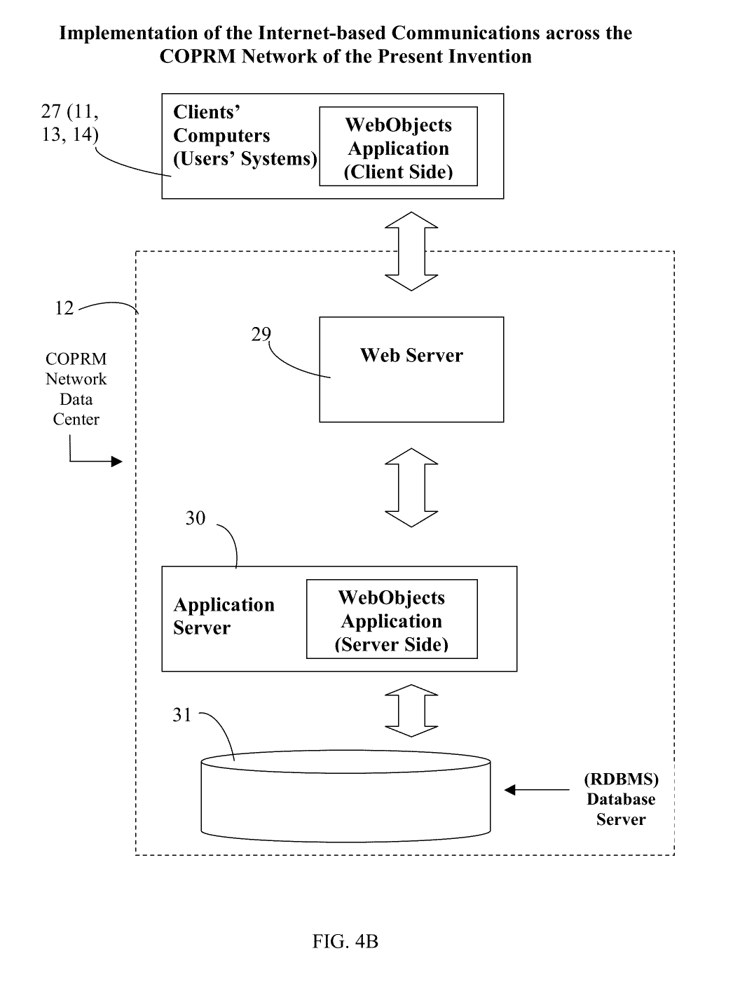

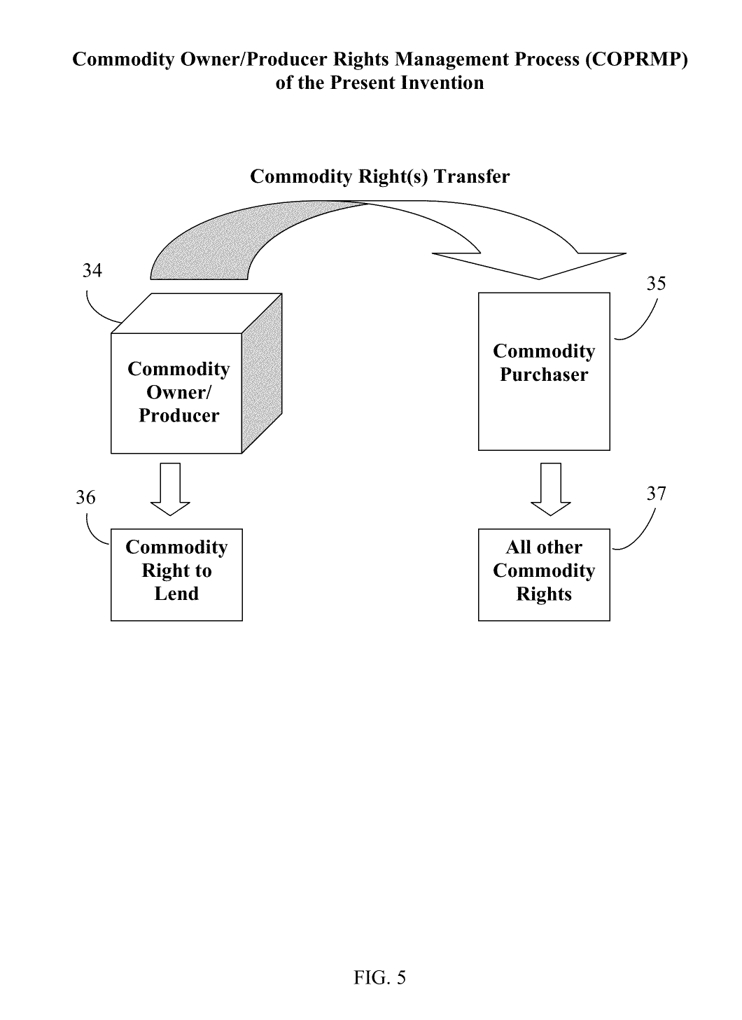

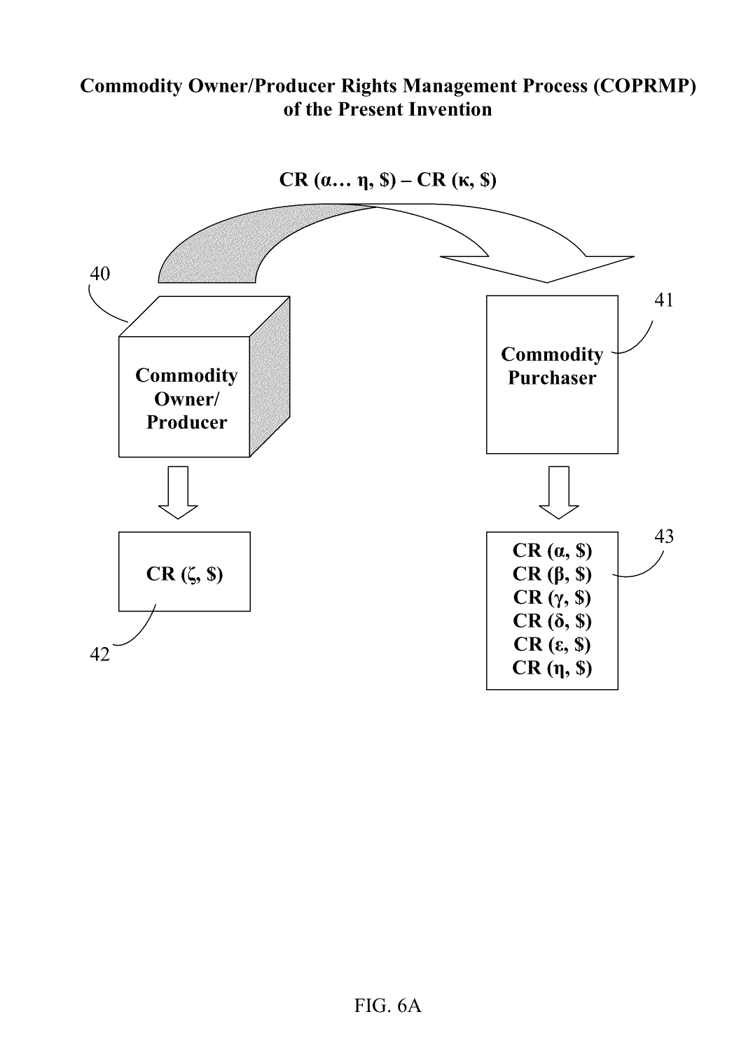

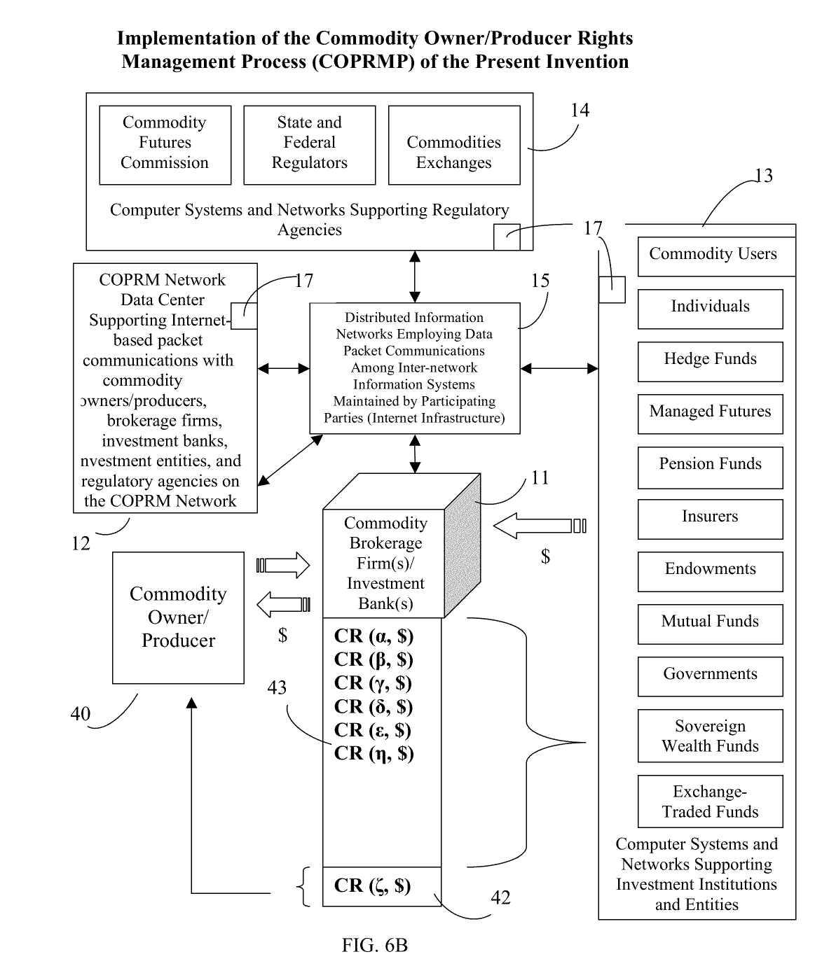

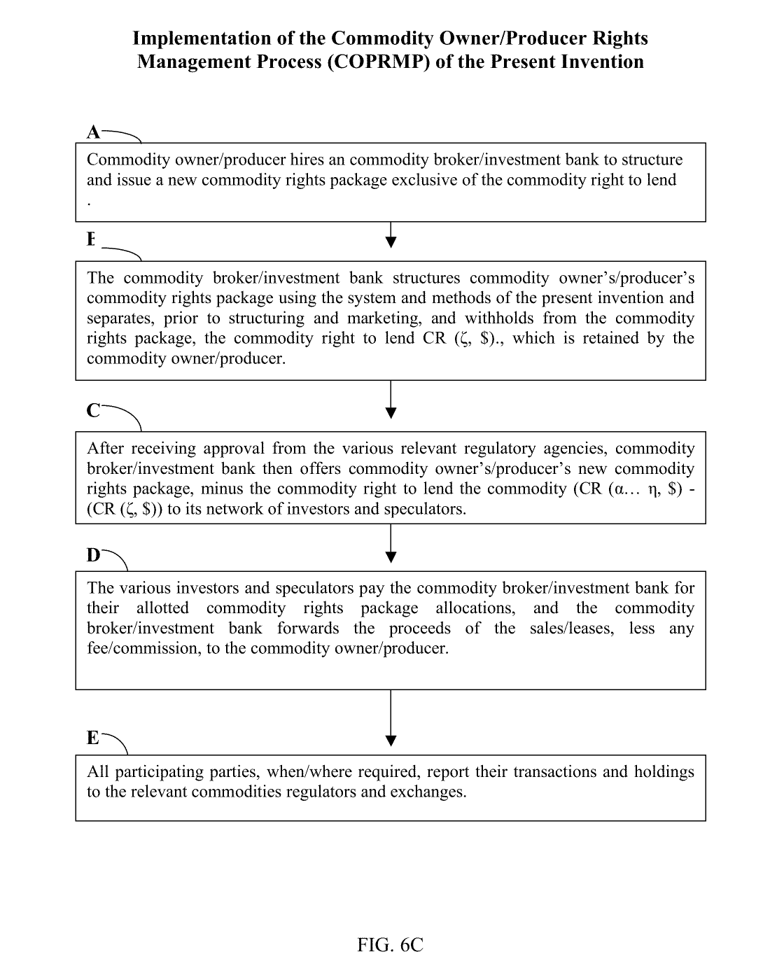

As shown in FIGS. 4 through 7C, the COPRM network of the present invention 10 supports services necessary to carry out the COPRMP illustrated in FIG. 5, and the COPRMP illustrated in FIGS. 6A, 6B and 6C of the present invention. Preferably, the COPRM network 10 is designed and implemented as an industrial-strength carrier-class Internet-based financial information communications network of an object-oriented system engineering (DOSE) design, as taught in Applicant's co-pending U.S. application Ser. Nos. 11/328,433 and 11/651,413, each incorporated herein by reference in its entirety.

As shown in FIG. 4, the COPRM network 10 comprises a diverse arrangement of computer systems (client and server machines) and networks interfaced with the infrastructure of the Internet, namely: computer systems (client and server machines) and networks supporting brokerage firms and investment banks 11; computer systems (client and server machines) and networks supporting regulatory agencies 14; computer systems (client and server machines) and networks supporting investment institutions and entities 13; computer systems (client and server machines) and networks supporting commodity owners/producers 16; and the COPRMP Data Center 12 supporting Internet-based packet communications with the brokerage firms, investment banks, investment entities, and regulatory agencies on the COPRMP network.

As will be described in greater detail hereinafter, the COPRMP Data Center 12 supports various information services between the various computer systems within the network, and among its various users. The COPRMP Data Center 12 will typically include arrays of relational database servers (RDBMS), application servers, and web and other communication servers, arranged in a three-tier structure, and secured by network firewalls, routers, switches and the like, well known in the art.

Each computer system and network within network groups 11, 13, 14 and 16, will typically include arrays of relational database servers (RDBMSs), application servers, and web and other communication servers, arranged in a three-tier structure and secured by network firewalls, routers, switches and the like, in addition to an arrangement of client machines supporting GUI interfaces, with which human users interface in a manner well known in the art.

In practice, the object-oriented COPRM network (system) will be developed using available object-oriented technology. Such object-oriented system development can involve any suitable Java-based, object-oriented integrated development environment (IDE) e.g. WebObjects 5.2 by Apple Computer Inc, Websphere IDE by IBM, or Weblogic IDE by BEA; or another object-oriented programming language such as C sharp, supported by the Microsoft® Visual Studio 2005. NET IDE.

FIGS. 4A and 4B show two alternative implementations of the enterprise-level COPRMP network of the present invention 12 shown in FIG. 4 using the WebObjects® IDE and Java Application Server 21, 22, 29, 30. Although it is understood that other IDE's and server technology platforms can be used to implement and deploy server components of the COPRMP Data Center 12. In FIG. 4A, the COPRMP network implementation involves using Web-based clients that can access services on the COPRMP network using http, well known in the art. In FIG. 4B, the COPRMP network implementation involves using clients programs running on the OS of the client machine, so that the user can access services on the COPRMP network using TCP/IP or other communication protocols known in the art. In other embodiments of the COPRMP network of the present invention, including those shown in FIGS. 4, 7, and 8, combinations of these two approaches can be used in combination, in a manner known in the enterprise level object-oriented system engineering (DOSE) art.

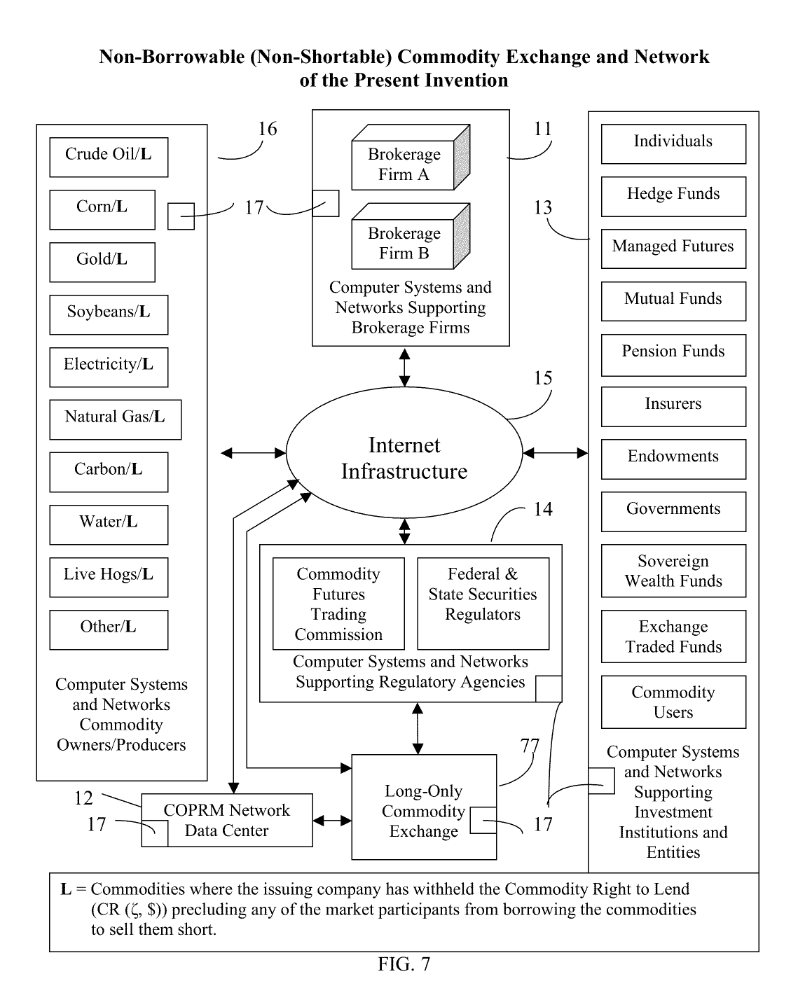

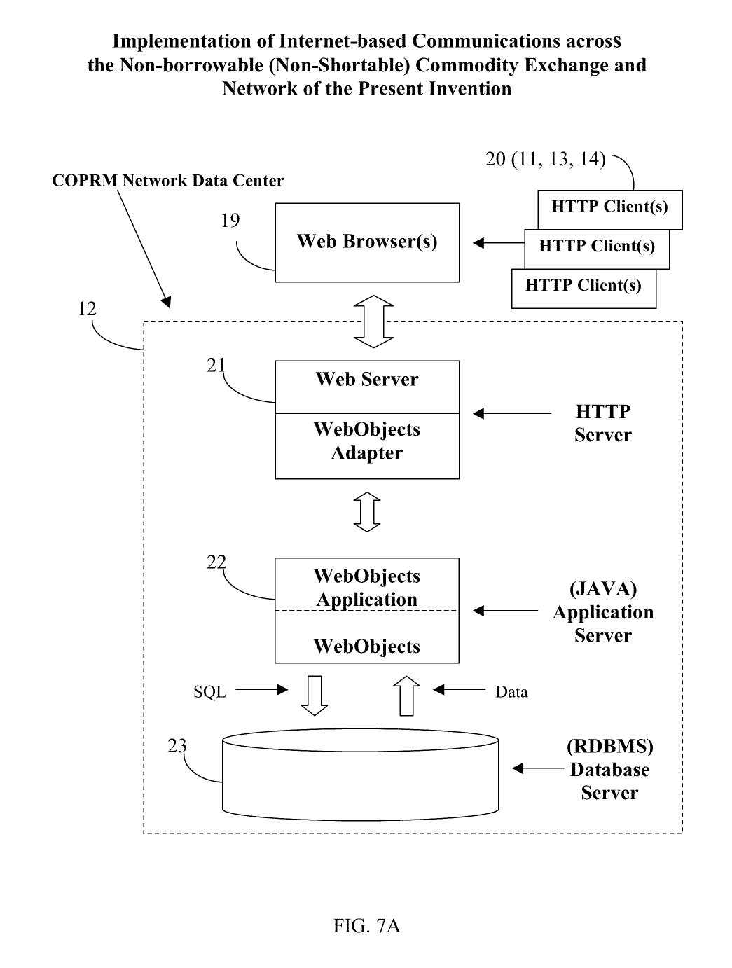

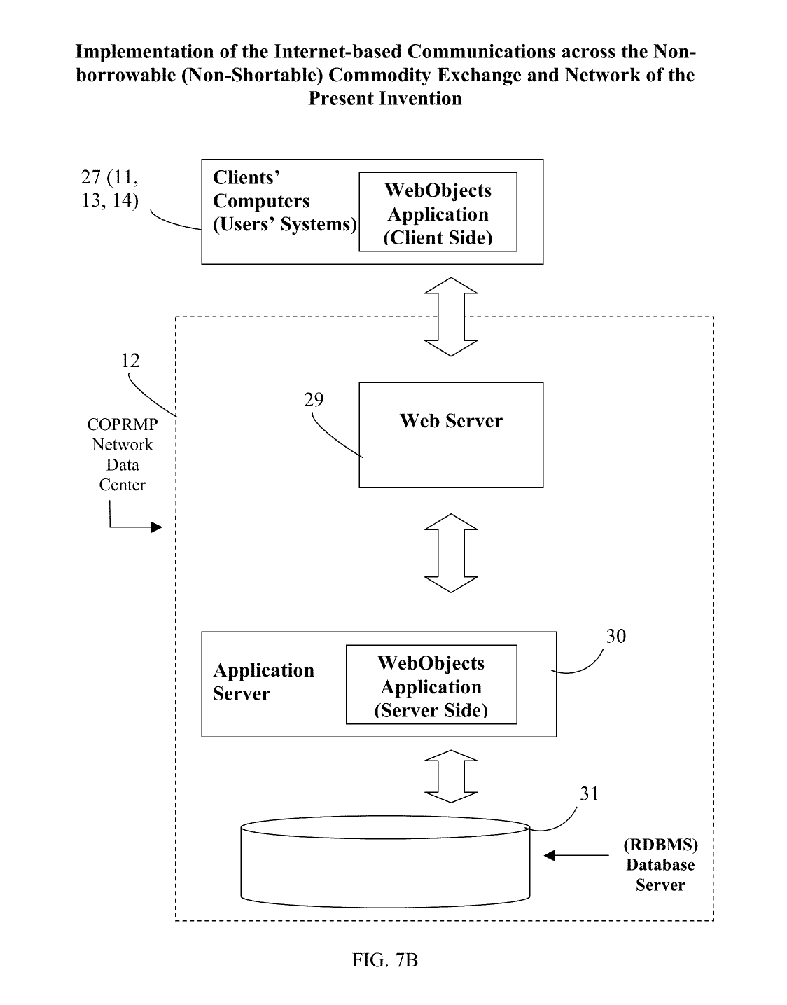

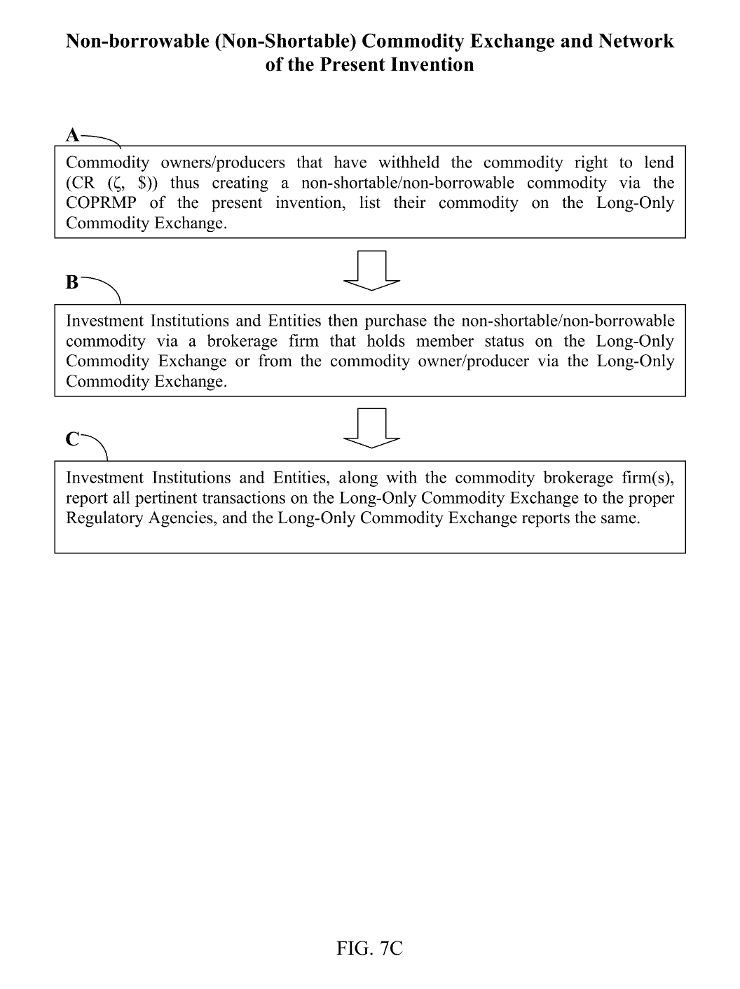

In FIG. 7, another embodiment of the COPRM network of the present invention is shown, which is similar to the network in FIG. 4, except that the COPRM network embodiment shown in FIG. 7 further includes a Long-Only Commodity Exchange 77, which supports the non-borrowable (non-shortable) commodity exchange process illustrated in the process flow chart of FIG. 7C. The Long-Only Commodity Exchange 77 can be realized using the same DOSE technology used to implement the COPRMP Data Center 12 of FIG. 4.

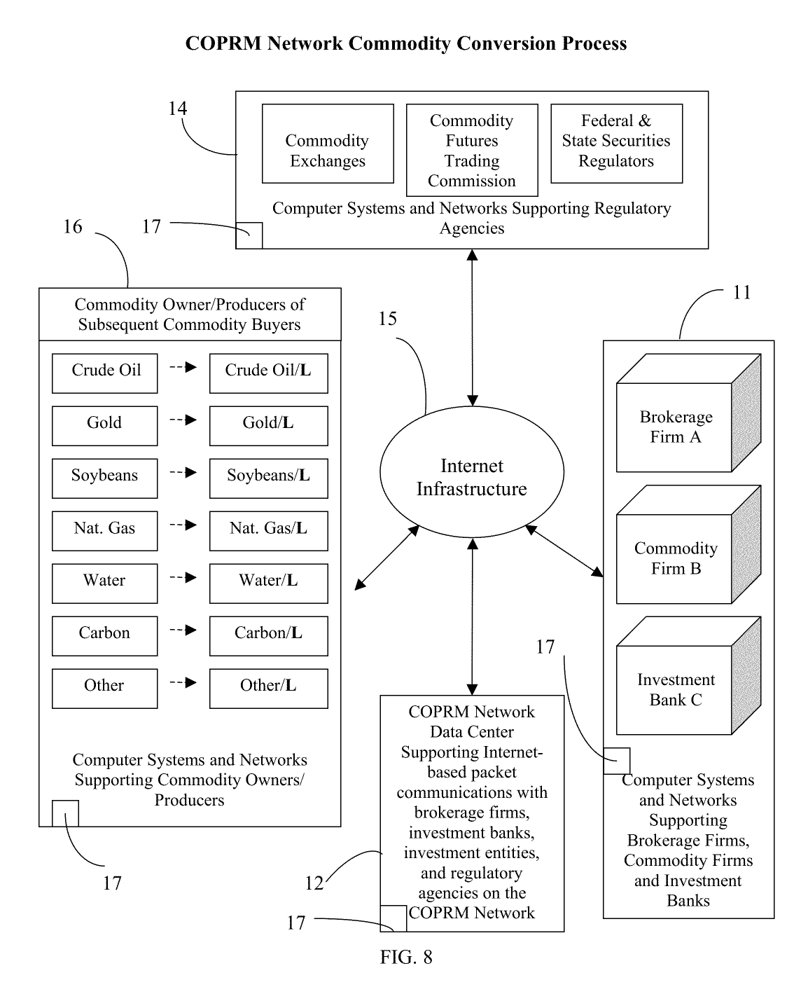

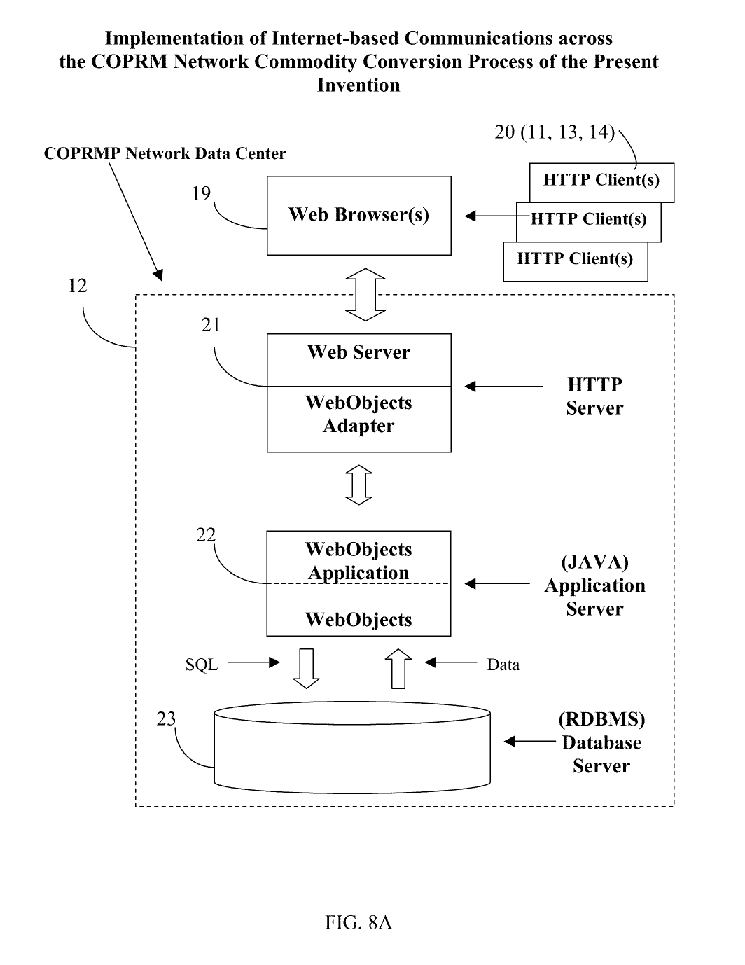

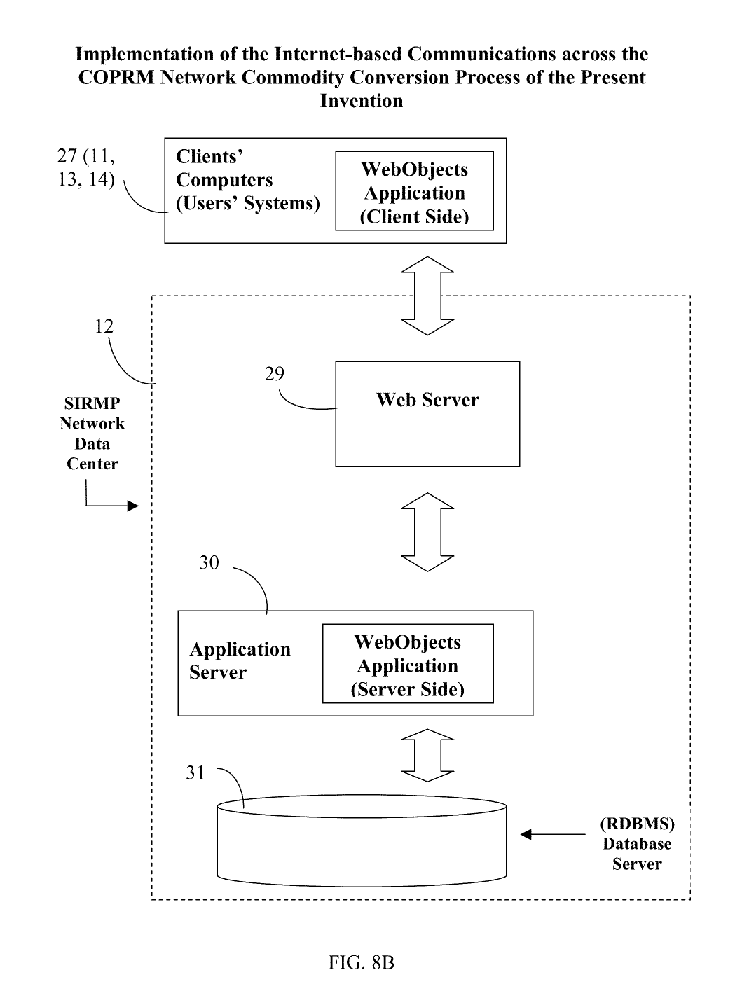

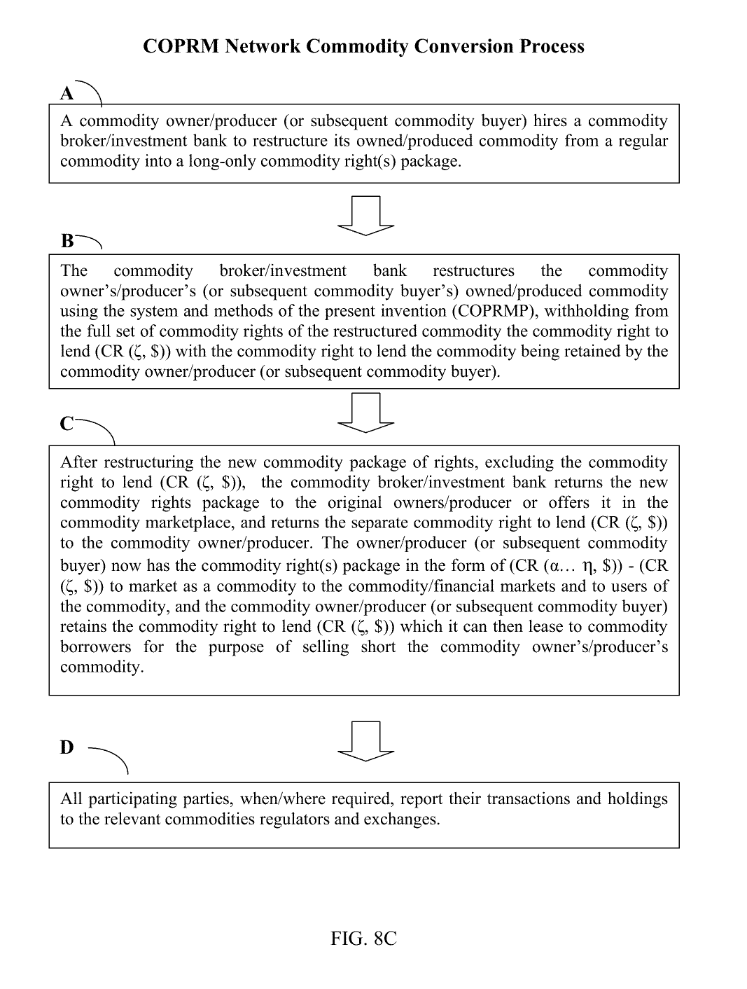

In FIG. 8, another embodiment of the COPRM network of the present invention is shown, which is similar to the network in FIG. 4, except that it supports the COPRMP Commodity Conversion Process of the present invention, illustrated in the block of FIG. 8, and the process flow chart of FIG. 8C.

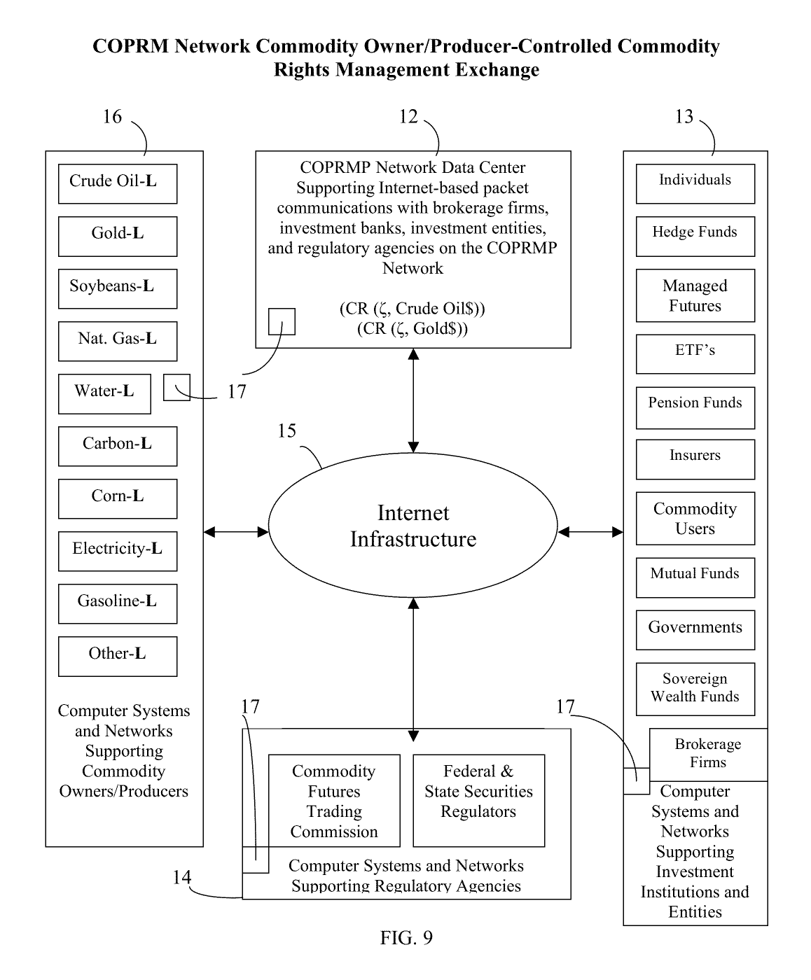

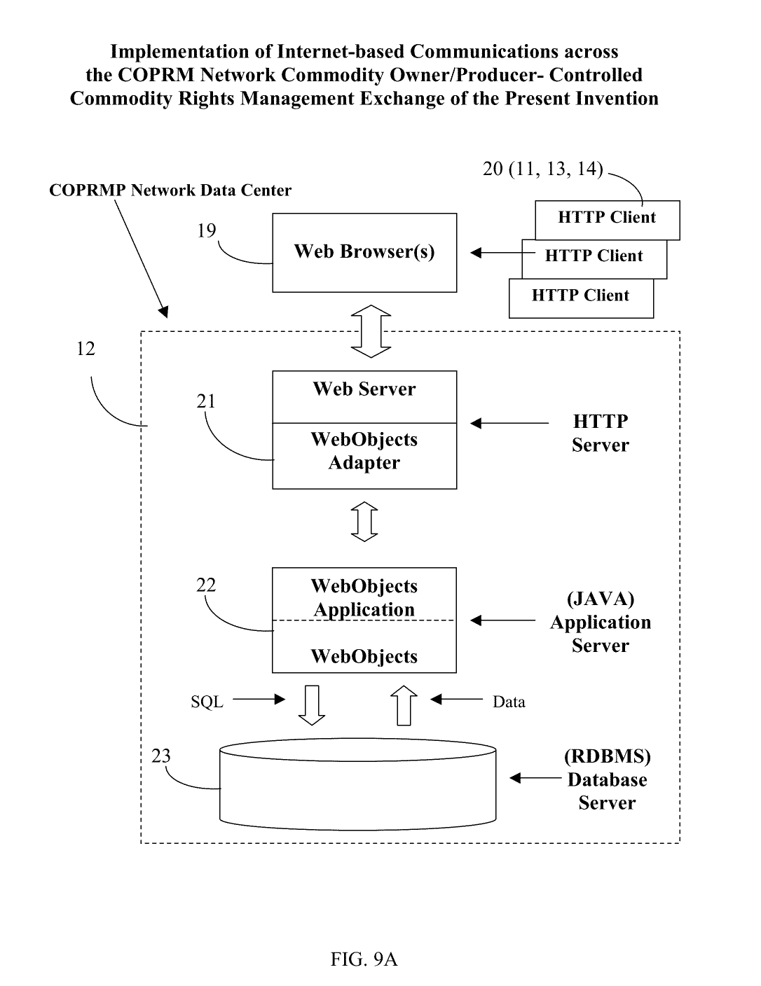

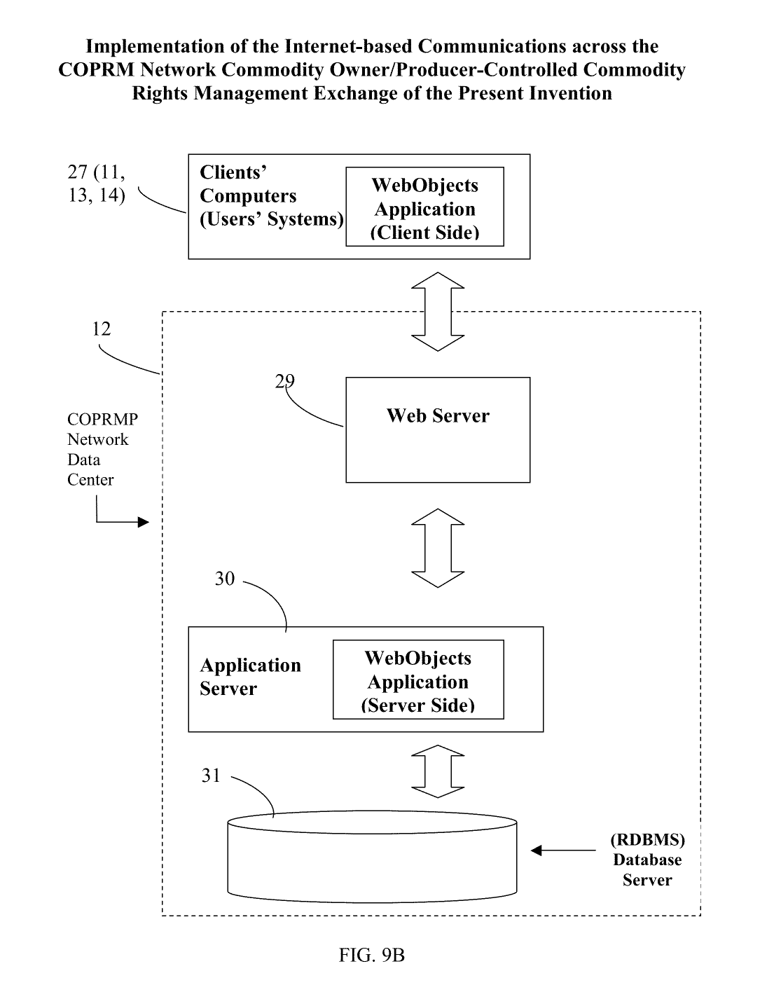

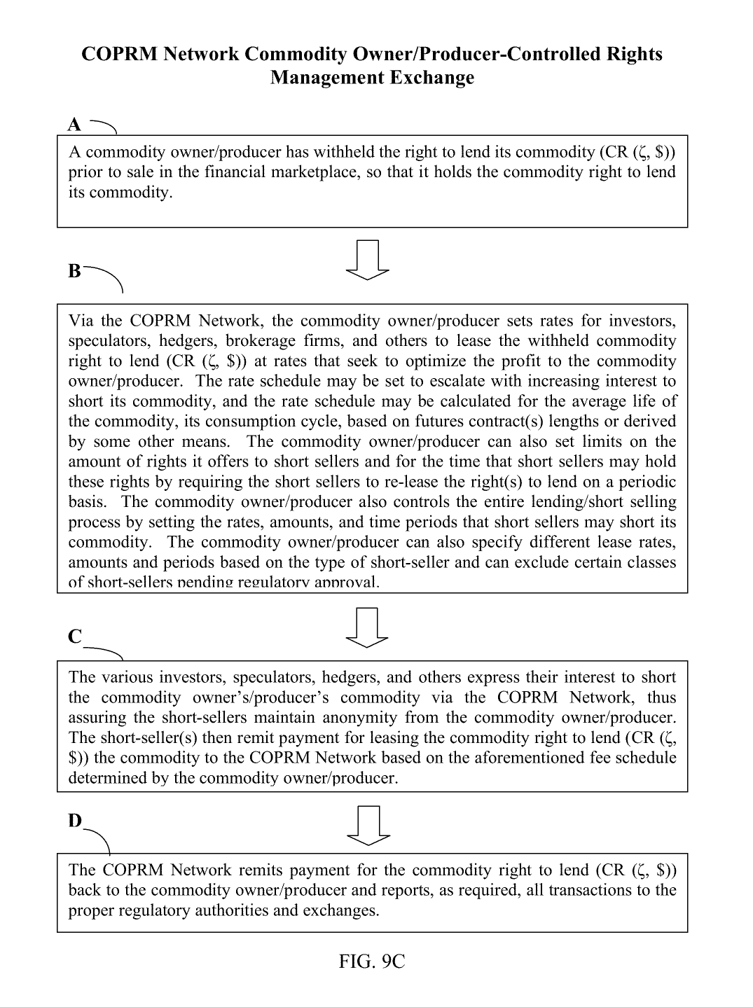

In FIG. 9, yet another embodiment of the COPRM network of the present invention is shown, which is similar to the network in FIG. 4, except that the COPRM network embodiment shown in FIG. 9 further supports the Commodity Owner/Producer Controlled Rights Management Exchange illustrated in flow chart of FIG. 9C.

It is appropriate at this juncture to provide a brief overview of the Internet-Based COPRM network present invention.

### Brief Overview of the Internet-Based COPRM Network of the Present Invention

The Internet-based COPRM network of the present invention operates in a commodity/financial marketplace, and comprises an information network infrastructure operably connected to the infrastructure of the Internet, as shown in FIG. 4. The COPRM network includes one or more commodity owners/producers, and a network level financial accounting system 17 that is supported by the web, application and RDBMS servers in the Data Center 12, and various component servers distributed throughout the COPRM network of the present invention, over participating companies, governments, government agencies, financial institutions, and investors. The network level financial accounting system 17 is a component of the object-oriented software-based system that is supported by the web, application and RDBMS servers configured according to a multi-tier network architecture, residing in the COPRMP Data Center 12, and various component servers distributed over the network of participating commodity owner/producers, government agencies, financial institutions, and investors.

The network-level financial accounting system 17 (i) recognizes and accounts for a set of commodity rights possessed prior to commodity sale/lease/production by an owner/producer of commodities and (ii) ensures that said set of commodity rights is unbundled, separated into a plurality of individual commodity rights (CR (α . . . η, $)), including the commodity right to lend (CR (ξ, $), and recombined into new, marketable commodity rights packages that exclude the commodity right to lend (CR (ξ, $) (or other subsets of commodity rights).

In accordance with the principles of the present invention, the commodity owner/producer of a commodity (i) withholds from, and prior to, a commodity's sale/lease/production, the commodity right to lend (CR (ξ, $)) the commodity in order to preclude lending/borrowing of the commodity and, thus, preclude short sales of the commodity or, (ii) restructures a sold/leased/produced commodity to exclude from the new commodity right(s) package, and to retain, the commodity right to lend (CR (ξ, $)) the commodity in order to preclude lending/borrowing of the commodity and, thus, preclude short sales of the commodity.

When a transfer of the individual right to lend a commodity occurs, the Internet-based COPRM system/network automatically accounts for the location of that commodity right and collects and remits proper payment in exchange for those rights.

### Commodity Owner/Producer Rights Management Process (COPRMP) of the Present Invention

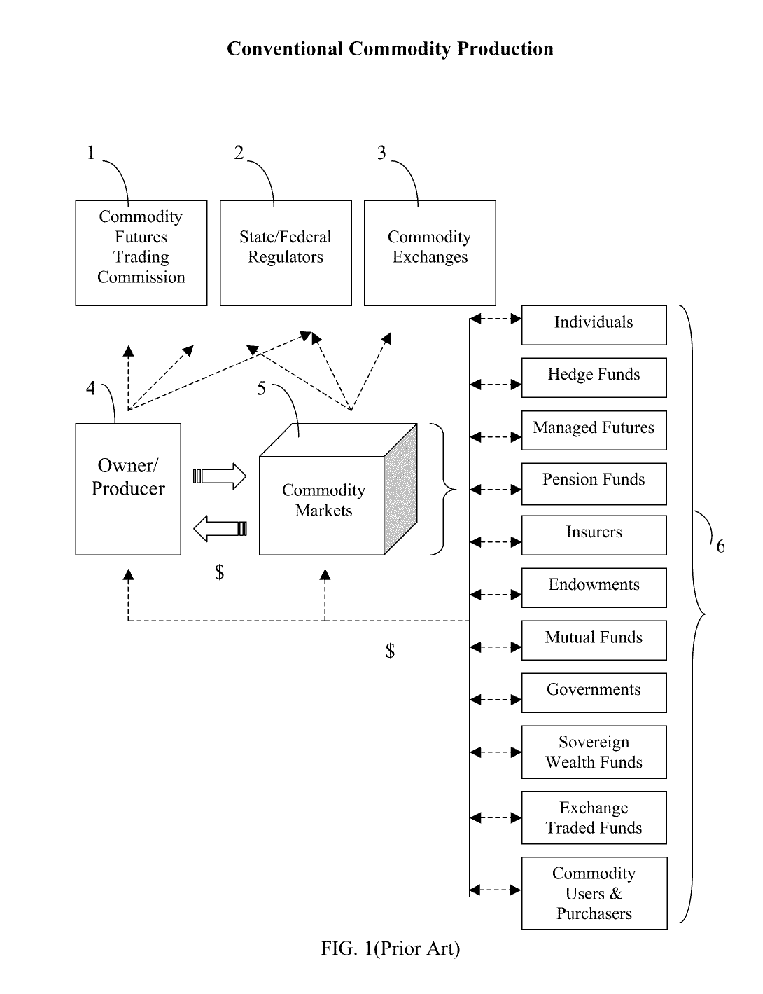

As shown in FIG. 5, the Commodity Owner/Producer Rights Management Process (COPRMP) of the present invention represents a significant improvement over the conventional commodity ownership/production/trading processes, illustrated in FIG. 1. In FIG. 5, the COPRMP is shown with a commodity owner/producer 34 withholding, prior to sale/lease/production, the right to lend 36 its commodity in order to allow a commodity owner/producer 34 to prevent that commodity, at sale/lease/production (or thereafter), from being lent to speculators and investors for the purpose of borrowing that commodity to short-sell it into the market; at the same time, all of the other commodity rights 37 within the bundle possessed prior to issuance by the commodity owner/producer 34 are issued to purchaser 35 of the commodity for full use by an owner or holder to maximize the utility of the commodity held in the global commodity/financial marketplace, in accordance with the principles of the present invention.

By withholding the right to lend the commodity prior to its sale/lease/production, the commodity owner/producer has effectively precluded a short-sale of the commodity, as it cannot be sourced and borrowed by a speculator or investor for the purpose of selling it short. Also, by withholding the right to lend a commodity 36 prior to sale//lease/production, the commodity owner/producer 34 has also effectively precluded naked short-selling (an illegal but common practice) of the commodity because all market participants, brokers and dealers will be aware that the commodity cannot be lent to be shorted. The commodity owner/producer 34 has effectively prevented short-selling of this commodity making it safer for long-term investors to purchase and hold the commodity rights package, because only those actually holding the commodity rights package will be able to sell it to other interested buyers, and because the actual commodity will not be available for those looking to sell it short as a hedge against derivative instruments bought/sold on the underlying commodity. If it is impossible to hedge derivative instruments by shorting a commodity rights package, there will be less speculative selling pressure on the actual commodity, which will give commodity owners/producers greater flexibility in raising capital or borrowing capital to fund future commodity production.

The practice of short-selling is often defended with the argument that it adds liquidity to the market. To combat the potential issue of reduced liquidity, the commodity owner/producer 34 could simply increase the amount of the commodity sold/leased/produced and lower its price to raise a similar amount of money. The increased amount of the commodity will help provide additional market liquidity.

### Commodity Issuer Rights Management Process (COPRMP) of the Present Invention

As shown in FIG. 6A, the COPRMP represents a significant improvement over the conventional commodity sale/lease/production (Prior Art) as illustrated in FIG. 1. In this figure, the COPRMP is shown with a commodity owner/producer 40 withholding the individual right to lend a commodity (CR (ξ, $)) 42 possessed by an commodity owner/producer 40 prior to a commodity's sale/lease/production, in order to allow a commodity owner/producer 40 to prevent that commodity, at sale/lease/production (or thereafter), from being lent to speculators and investors for the purpose of borrowing that commodity to short-sell it into the market, while all of the other commodity rights within the bundle possessed by the commodity owner/producer 40 prior to sale/lease/production (CR (α . . . η, $))−(CR (ξ, $)) 43 are sold to purchasers 41 of the commodity for full use by a commodity rights package purchaser 40 to maximize the utility of the commodity held in the global financial marketplace, but without being able to lend it to short-sellers, in accordance with the principles of the present invention.

By withholding the commodity right to lend (CR (ξ, $)) 42 prior to commodity sale/lease/production, the commodity owner/producer 40 has effectively precluded a short-sale of the commodity, either by the initial purchaser or lessee 41 or, by subsequent purchasers or lessees 41; it cannot be sourced and borrowed by a speculator or investor for the purpose of selling it short. Also, by withholding the commodity right to lend (CR (ξ, $)) 42 prior to sale/lease/production, the commodity owner/producer 40 has also effectively precluded naked short-selling (an illegal but common practice) of the commodity because all market participants, brokers and dealers will be aware that the commodity rights package cannot be lent to be sold short. The commodity owner/producer 40 has effectively prevented short-selling of the commodity, making it safer for long-term investors to purchase and hold, because only those actually holding the commodity rights package will be able to sell it to other interested buyers, and because the commodity will not be available for those looking to sell it short as a hedge against derivative instruments bought/sold on the underlying commodity. Furthermore, by precluding speculators and investors from selling short the commodity 43, speculators and investors cannot pressure an owner's/producer's commodity in order to make it more expensive for a commodity owner/producer to raise/borrow new capital for commodity production, nor can speculators and/or investors force a commodity owner/producer to sell or lease its commodity at prices that have been depressed by the speculators and/or investors.

As illustrated in FIG. 6B, the implementation of the Commodity Owner/Producer Rights Management Process (COPRMP) of FIG. 5 is shown incorporating the COPRMP Data Center 12, a commodity owner/producer 40, a commodity brokerage/investment banking firm (investment bank, merchant bank, bank or other financial institution) 11, various commodity-purchasing entities (individuals, hedge funds, mutual funds, pension funds, insurers, endowments, municipalities, governments, sovereign wealth funds and exchange-traded funds) 13, various regulatory agencies, including the Commodity Futures Trading Commission (CFTC) and federal and state regulators, and, finally, the various commodities exchanges 14. Each of the aforementioned participants is linked to the others via various communications networks and via the Internet 15.

As shown in FIG. 6B, a commodity owner/producer 40 hires a commodity brokerage/investment bank 11, utilizing the COPRMP Data Center 12 of FIG. 4, to help structure the commodity owner's/producer's commodity right(s) package in order to allow the commodity owner/producer to maintain the commodity right to lend (CR (ξ, $)) 42. The commodity broker/investment bank 11 structures the commodity owner's/producer's 40 new commodity right(s) package 43 and, at the instruction of the commodity owner/producer 40, incorporates the system and method of the present invention, whereby the commodity broker/investment bank 11 recognizes that a commodity consists of a bundle of rights (CR (α . . . η, $)) 42 and 43, which can be unbundled, separated, and recombined into an individual, saleable/leaseable commodity package of rights. From this bundle of commodity rights, the commodity right to lend (CR (ξ, $)) 42 is withheld prior to structuring and sale/lease of the commodity right(s) package in order to allow a commodity owner/producer 40 to either preclude or to control short-selling of its commodity in the global commodity/financial marketplace.

The commodity broker/investment bank 11 structures the commodity owner's/producer's 40 commodity rights package (in this example) so that the commodity owner/producer withholds the right to lend its commodity (CR (ξ, $)) 42 prior to sale of the new commodity right(s) package 43, which now is represented by the equation (CR (α . . . η, $))−(CR (ξ, $)) 43. The commodity broker/investment bank 11 then offers for purchase or lease the commodity owner's/producer's 40 new commodity right(s) package 43 to a broad array of investors including: individuals, hedge funds, managed futures funds, pension funds, insurers, endowments, mutual funds, governments, sovereign wealth funds and exchange-traded funds 13. These investors pay the commodity broker/investment bank 11 for their commodity right(s) packages 43, and the commodity broker/investment bank 11 forwards the proceeds of the offering to the commodity owner/producer 40 less any previously agreed commission for the underwriter's services. The commodity owner/producer 40, the commodity broker/investment bank 11 and, in some cases, various of the commodity rights package purchasing/leasing entities 13, report all facets of the commodity right(s) package's structure, offering terms, sale/lease and purchases to the various regulatory agencies 14 as represented in FIG. 6B.

The commodity owner/producer 40 has now issued a new commodity right(s) package 43 and raised new capital but has withheld from the purchasers or lessees 13 the commodity right to lend (CR (ξ, $)) 42 this commodity for the purposes of short-selling this commodity, as speculators and investors cannot borrow this commodity from the purchasers or lessees of the newly-structured commodity right(s) packages 43 for the purpose of selling them short. Furthermore, it will be much harder for speculators and investors to purchase bearish derivative instruments on the commodity owner's/producer's 40 newly-structured commodity right(s) packages 43, as the potential sellers of those bearish derivative instruments will be unable to borrow the commodity owner's/producer's 40 newly-structured commodity right(s) packages 43 to sell short in an effort to hedge their sale of the bearish derivative instruments. The commodity owner/producer 40 has also effectively precluded leveraged, bearish exchange-traded funds (ETF's) from including the new commodity right(s) package 43 in their funds, as the ETF's are also precluded from borrowing the commodity to sell it short. Holders of the commodity owner's/producer's 40 new commodity right(s) package 43 enjoy all of the benefits (commodity rights) of normal commodity ownership, except that they cannot lend the new commodity right(s) package 43 to investors and speculators for the purpose of short-selling it.

As indicated at Block A in FIG. 6C, the Commodity Owner/Producer hires an investment bank/commodity underwriting firm, utilizing the COPRMP of FIG. 5, for the purpose of structuring and issuing a new commodity right(s) package to withhold the commodity right to lend (CR (ξ, $)) the commodity. At Block B, the investment bank/commodity underwriting firm structures the commodity owner's/producer's commodity right(s) package by withholding/excluding from the new commodity right(s) package the commodity right to lend (CR (ξ, $)) from the commodity owner's/producer's new commodity right's package, which is retained by the commodity owner/producer. At Block C, the investment bank/commodity underwriting firm then issues the commodity owner's/producer's new commodity right(s) package ((CR (α . . . η, $)−(CR (ξ, $)), to its network of investors and speculators for sale or lease. At Block D, the investors and speculators pay for the commodity owner'/producer's new commodity right(s) package, and the investment bank/commodity underwriting firm delivers the proceeds from the new commodity right(s) offering to the commodity owner/producer, less any fees/commissions; the commodity right to lend (CR (ξ, $)) the new commodity right(s) package has been withheld and retained by the commodity owner/producer. At Block E, all parties report required transactions to the various commodity regulators and commodity exchange(s).

### COPRM Network of the Present Invention Supporting a Non-Borrowable (Non-Shortable) Commodity Exchange

As illustrated in FIG. 7, the non-borrowable (non-shortable) commodity exchange is shown, wherein commodity owners/producers that have issued commodities right(s) packages and have withheld commodity right to lend (CR (ξ, $)) those commodities 42, via the COPRMP 12, have listed their commodity right(s) packages 16 (“Crude Oil/L” is an example of these “long-only” commodities). As these commodity right(s) packages, designated by the “L” after their normal commodity symbol/name for “long-only”, cannot be lent by the owner/holder of these commodity right(s) packages to other investors, hedgers and/or speculators 13 for the purpose of selling the commodities short, these commodities right(s) packages 16 cannot be sold short.

Similarly, these commodity right(s) packages are not subject to naked-shorting, as they trade on a “Long-Only Security Exchange” 77, and the “L” in each commodity right(s) package symbol/name designates it as a “long-only” commodity right(s) package, as the commodity right to lend (CR (ξ, $)) 42 has been withheld from the commodity right(s) package 43 prior to sale/lease/production, leaving the subset of commodity rights (CR (α . . . η, $)) 43−(CR (ξ, $)) 42 with the new commodity right(s) package.

Most importantly, as shown in FIG. 7, all trades by market participants (individuals, hedge funds, managed futures funds, mutual funds, pension funds, insurers, endowments, governments, sovereign wealth funds, exchange-traded funds and others) 13 are conducted via various commodity accounts held at the market participants' commodity brokerage firms 11 (Long-Only Security Exchange 77 Members). As such, the commodity brokerage firms 11 have access to the market participants' positions and can assure that only commodity right(s) packages 16 already held by a market participant can be sold into the market, further precluding short sales of any type. In the event that market participants 13 (hedge funds and other speculators and investors) are concerned about secrecy of their trading, they can sell the “long-only” commodity right(s) packages with a commodity brokerage firm other than that where they hold their “long-only” commodity right(s) packages, as long as proper netting agreements are in place—these will also serve to assure that only commodity right(s) packages already owned/held can be sold.

As with other commodity markets and exchanges, all relevant transactions are reported to the various regulatory agencies 14 and monitored by the same.

FIGS. 7A and 7B show two alternative implementations of the enterprise-level COPRMP Data Center 12 using the WebObjects® IDE and Java Application Server 21, 22, 29, 30, although it is understood that IDE's and server technology platforms can be used to implement and deploy server components of the COPRMP Data Center 12.

FIG. 7C is a flow chart depicting the non-borrowable (non-shortable) commodity exchange and network of FIG. 7. As indicated at Block A, commodity owners/producers that have sold/leased and/or converted, their owned/produced commodities into non-shortable/non-borrowable commodity right(s) packages via the COPRMP, list their commodity right(s) packages on the Long-Only Commodity Exchange. At Block B, investment institutions and entities then purchase or lease the non-shortable/non-borrowable listed commodity right(s) packages via a commodity brokerage firm that holds member status on the Long-Only Commodity Exchange. Finally, at Block C, the investment institutions and entities, along with the commodity brokerage firm(s), report all pertinent transactions on the Long-Only Commodity Exchange of the present invention to the proper regulatory agencies.

### COPRM Network of the Present Invention Supporting Commodity Conversion Process

As is illustrated in FIG. 8, the COPRMP commodity conversion process of the present invention allows owners/producers of commodities 16 to convert already bought/leased/produced commodities, which can be borrowed and sold short, into commodity right(s) packages by withholding the commodity right to lend (CR (ξ, $)), creating “long-only” commodities, which cannot be borrowed/sold-short, by employing the COPRMP Data Center 12 of FIG. 4. This can be done by either the original commodity owner/producer or by a subsequent buyer/lessee of the commodity if the original owner/producer of the commodity has not withheld already the commodity right to lend (CR (ξ, $)).

A commodity owner/producer 16, or a subsequent commodity buyer 16 who owns a commodity, contacts a commodity broker/investment bank 11 to convert a commodity into a “long-only” commodity by withholding the commodity right to lend (CR (ξ, $)). Through the conversion process, the commodity owner/producer (or subsequent buyer) 16 hires an commodity broker/investment bank 11 utilizing the COPRMP Data Center 12 of FIG. 4, to withhold and retain the commodity right to lend (CR (ξ, $)) from a new commodity right(s) package consisting of (CR (α . . . η, $))−(CR (ξ, $)), precluding the new commodity right(s) package from being lent to speculators, investors and/or hedgers for the purpose of selling it short and betting against the fortunes of the original commodity owner/producer or against those of the subsequent buyer of the commodity.

Once the notice of conversion has been sent (and approval received, if needed), the commodity owner/producer (or subsequent commodity buyer) 16 enlists the services of one or more investment banks 11 to complete the commodity conversion process. The investment bank(s) 11 utilize(s) the system and methods of the COPRMP 12 of the present invention to restructure and reissue the new commodity right(s) packages, (CR (α . . . η, $))−(CR (ξ, $)), pursuant to the commodity owner's/producer's (or subsequent commodity buyer's) 16 desires which, in the example shown in FIG. 8, involve the commodity owner/producer (or subsequent commodity buyer) 16 withholding either the commodity right to lend (CR (ξ, $)) or other commodity right(s) from the new commodity right(s) package (CRP).

Once restructured and reissued by the investment bank(s) 11, the commodity owner/producer (or subsequent commodity buyer) 16 using the system and methods of the COPRMP Data Center 12 of FIG. 4, has effectively precluded from short-selling the now “long-only” commodity, which, in this example, are designated by an “L” following the commodities' standard symbol/name, by speculators, investors and/or hedgers.

All parties report required transactions and information to the relevant regulatory agencies and to the proper commodity markets and exchange(s) 14.

FIGS. 8A and 8B show two alternative implementations of the enterprise-level COPRMP Data Center 12 of FIG. 4 using the WebObjects® IDE and Java Application Server 21, 22, 29, 30, although it is understood that IDE's and server technology platforms can be used to implement and deploy server components of the COPRMP Data Center 12.

FIG. 8C is a flow chart depicting the COPRMP Commodity Conversion Process of FIG. 8. As indicated in Block A of FIG. 8C, a commodity owner/producer (or subsequent commodity buyer) hires a commodity broker/investment bank to restructure its commodity from a standard commodity into a long-only commodity right(s) package. At Block B, the commodity broker/investment bank restructures the commodity, using the system and methods of the present invention (COPRMP), and separates, and withholds, from the set of commodity rights restructured into a commodity right(s) package, the commodity right to lend (CR (ξ, $))—the commodity owner/producer (or subsequent commodity buyer) retains the commodity right to lend its commodity. At Block C, the commodity broker/investment bank either returns the new commodity right(s) package (CR (α . . . η, $))−(CR (ξ, $)) to the commodity owner/producer or sells or leases it to purchasers in the marketplace, and returns both the commodity right to lend (CR (ξ, $)) and the proceeds from the sale and/or lease to the original commodity owner/producer (or to the subsequent commodity buyer). The commodity owner/producer (or subsequent commodity buyer) can then lease the commodity right to lend (CR (ξ, $)) to commodity borrowers for the purpose of selling short the commodity. At Block D, all parties report required transactions to the various commodity regulators and commodity exchange(s).

### COPRM Network of the Present Invention Supporting a Commodity Owner/Producer—Controlled Rights Management Exchange

As shown in FIG. 9, the COPRMP commodity owner/producer-controlled rights management exchange of the present invention allows commodity owners/producers 16 to control the process through which their commodities can be sold short, taking control of the short-selling process out of the hands of investors, speculators, hedgers, brokerage firms and others 13, and allowing commodity owners/producers, to assert their ability to control, manage, and profit from, the short-selling process of their own commodities; the COPRMP Data Center 12 allows commodity owners/producers 16 to improve the shorting process by controlling and charging for the ability to short their commodities. This exchange differs from that shown in FIG. 7 77, as it allows commodity owners/producers 16 that have withheld the right to lend their commodities (or other commodity right(s)) to profit by leasing those rights to short-sellers 13.

In the example shown in FIG. 9, a commodity owner/producer 16 has withheld prior to sale, the commodity right to lend (CR (ξ, $)) its commodity. This allows commodity owner/producer to control completely the process required to short its commodity, as now any party interested in selling short the commodity must agree to terms set by the commodity owner/producer to borrow it to sell it short.

Through the COPRMP Data Center 12, the commodity owner/producer sets the various criteria for shorting its commodity. The commodity owner/producer sets the lease rates (can vary by type of commodity, average lifespan of commodity, average storage time of commodity, etc.), lease periods, determines the amount of total commodity supply to offer for short-selling, and sets any other parameters deemed important for leasing the right to lend its commodity.

Investors, speculators, hedgers, brokerage firms and others 13 then approach the COPRMP Data Center 12 of the present invention, via the Internet 15 or other methods of communication, to ascertain the various terms on which they can short various commodities by leasing the commodity right to lend (CR (ξ, $)). If one of the aforementioned parties agrees to the lease terms set by a commodity owner/producer for shorting its commodity, that party then remits the required money to lease the commodity right to lend (CR (ξ, $)) to the COPRMP Data Center 12, which distributes the money directly to the commodity owner/producer. This is an important process, as it allows a short-seller to maintain complete anonymity, which is something short-sellers complain about when regulations are proposed to make their processes more transparent; they argue that if a commodity owner/producer knows that they have shorted, or are interested in shorting, the commodity owner's/producer's commodity, that commodity owner/producer will not be forthcoming with information, etc. The COPRMP Data Center 12 allows short-sellers to lease the right to lend a commodity, directly, via the COPRMP Data Center 12, from the commodity owner/producer, on the commodity owner's/producer's terms, but with total anonymity. More importantly, the COPRMP Data Center 12 allows the commodity owner/producer to manage the entire commodity short-selling process and profit from it directly.

Because all of the short-selling transactions for the commodity right(s) package go through the COPRMP Data Center 12, it completely precludes naked short-selling, as the COPRMP Data Center 12 is able to allocate the commodity right to lend (CR (ξ, $)) for the commodity owner's/producer's commodity based on the commodity owner's/producer's pre-specified criteria.

All transactions are reported, as required to the various regulatory agencies 14.

FIGS. 9A and 9B show two alternative implementations of the enterprise-level COPRMP Data Center 13 of FIG. 9 using the WebObjects® IDE and Java Application Server 21, 22, 29, 30, although it is understood that IDE's and server technology platforms can be used to implement and deploy server components of the COPRMP Data Center 12.

FIG. 9C is a flow chart depicting the various steps of the COPRMP Commodity Owner/Producer-Controlled Commodity Rights Management Exchange depicted in FIG. 9. As indicated at Block A of FIG. 9C, a commodity owner/producer has either withheld the right to lend its commodity (CR (ξ, $)) prior to sale of a commodity right(s) package consisting of (CR (α . . . η, $))−(CR (ξ, $)), or has converted its commodity to withhold the commodity right to lend (CR (ξ, $)), so that it holds the commodity right to lend its commodity.

At Block B, via the COPRMP, the commodity owner/producer sets (e.g. using a web-based browser) rates for investors, speculators, hedgers, brokerage firms, and others to lease the withheld/retained right(s) to lend its commodity (CR (ξ, $)) at rates that seek to optimize profit for the commodity owner/producer. The rate schedule may be set to escalate with increasing interest to short its commodity. The commodity owner/producer also can set limits on the amount of the lending right (CR (ξ, $)) it offers to short sellers and, for the time that short sellers may hold these rights, by requiring the short sellers to re-lease the right(s) to lend on a periodic basis. The commodity owner/producer controls the entire shorting process by setting the lease rates and terms, which can vary by type of commodity, average lifespan of commodity, average storage time of commodity, commodity consumption cycle, futures contracts, etc, and time periods that short sellers may short its commodity. The commodity owner/producer can also specify different lease rates, amounts and periods based on the type of short-seller and can exclude certain classes of short sellers pending regulatory approval.

At Block C, the various investors, speculators, hedgers, brokerage firms, and others express their interest to short the commodity owner's/producer's commodity via the COPRMP, thus assuring that the short-sellers remain anonymous to the commodity owner/producer. The short-seller(s) then remit(s) payment for leasing the commodity right to lend (CR (ξ, $)) from the commodity owner/producer to the COPRMP based on the aforementioned fee schedule determined by the commodity owner/producer.

At Block D, the COPRMP remits payment for the commodity right to lend (CR (ξ, $)) back to the commodity owner/producer and reports, as required, all transactions to the proper regulatory authorities.

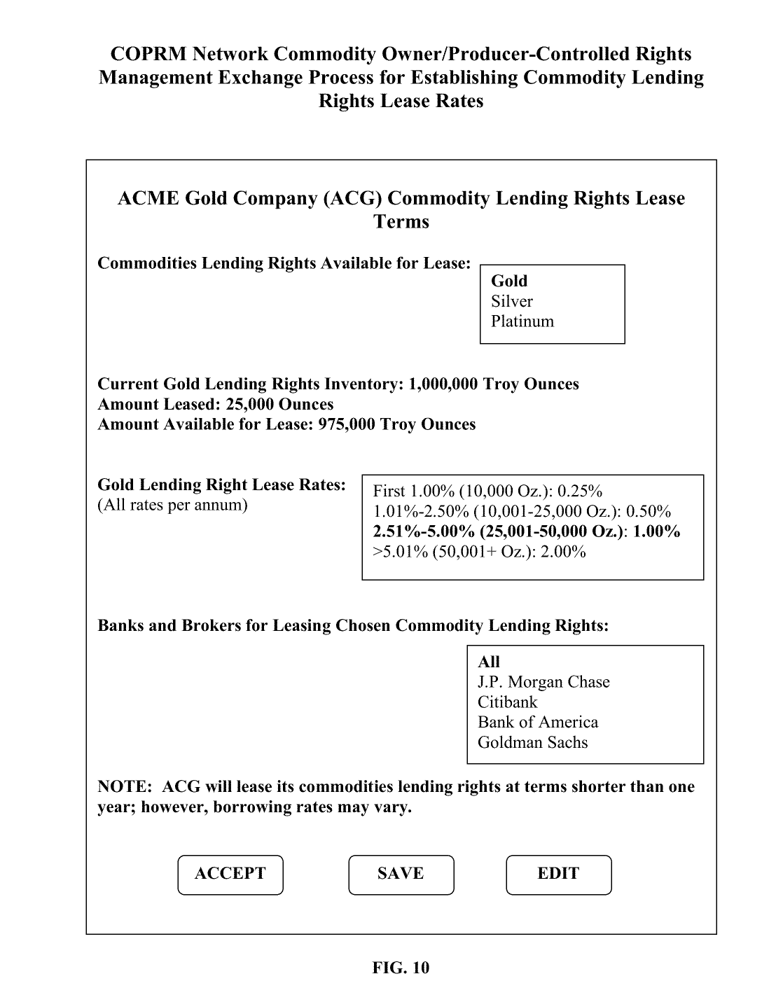

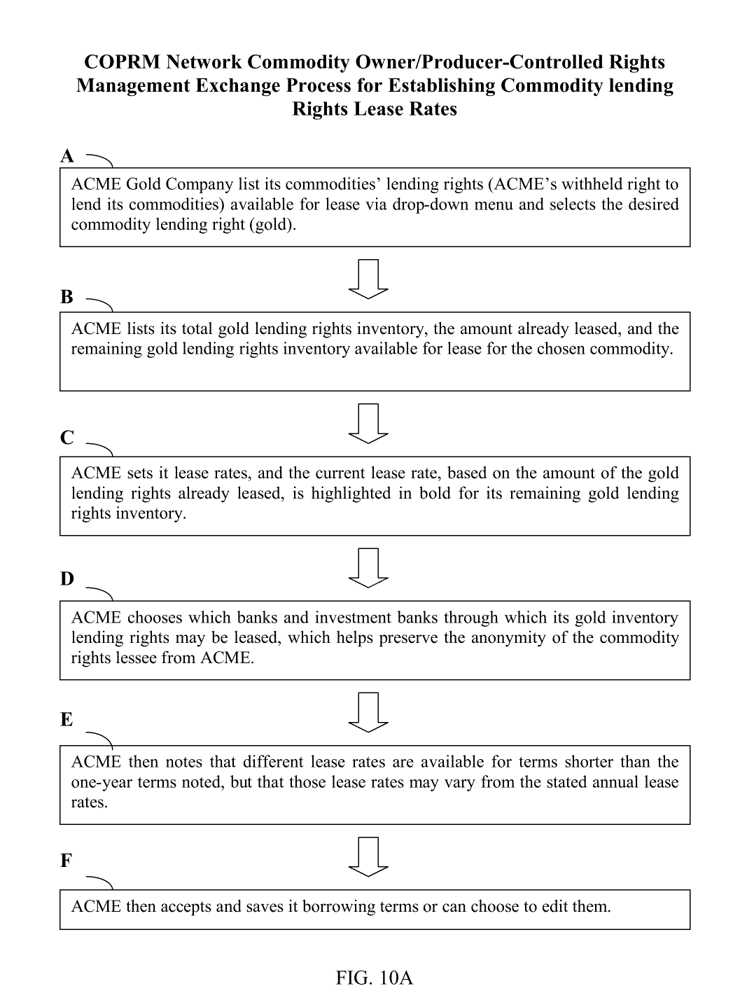

FIG. 10 is a COPRM Network Commodity Owner/Producer-Controlled Rights Management Exchange Process for Establishing Commodity Lending Rights Lease Rates graphical user interface (GUI) screen that allows a commodity owner/producer to set the lease terms for its commodity lending rights and through which, a commodity lending right lessor can specify lease terms and conditions from both from drop-down menus and by typing in pertinent information related to the lease of one or more commodity lending rights from the commodity owner/producer.

In this example, ACME Gold Company list its commodities' lending rights available for lease via drop-down menu and selects the desired commodity lending right—in this example, gold. Once the appropriate commodity lending right has been chosen, the GUI screen then shows the commodity owner's/producer's total gold inventory in Troy ounces, the amount of lending rights already leased, and the total remaining commodity lending rights available for lease.

The commodity owner/producer then sets (e.g. using a web browser) its own lease rates for the remaining inventory of commodity lending rights. The lease rate can be one flat rate for the entire lending rights inventory, or the commodity owner/producer can elect, as shown in this example, graduating lease rates so that as demand rises to lease its commodity lending rights, the lease rates for those lending rights also rises. This has the added effect of making excessive speculation more expensive for speculators while also increasing the lease income for the commodity owner/producer.

The commodity owner/producer then lists all of the banks, investment banks and commodity brokers through which its commodity lending rights are available for lease. While the commodity owner/producer may select only a few based on business relationships or other factors, it makes sense to select “All” available banks, investment banks and commodity brokers to broaden the market exposure for the commodity lending rights.

After selecting all of the aforementioned variables and eligible counterparts, the commodity owner/producer has added a note that other borrowing terms are available but that rates may vary from those posted

Finally, the commodity owner/producer can accept, save or edit the terms and conditions for leasing its gold commodity lending rights.

FIG. 10A is a flow chart depicting the various steps of the COPRM Network Commodity Owner/Producer-Controlled Rights Management Exchange Process for Establishing Commodity lending Rights Lease Rates depicted in FIG. 10.

At block A, ACME Gold Company list its commodities' lending rights (ACME's withheld right to lend its commodities) available for lease via drop-down menu and selects the desired commodity lending right (gold).

At Block B, ACME lists its total gold lending rights inventory, the amount already leased, and the remaining gold lending rights inventory available for lease for the chosen commodity.

At Block C, ACME sets it lease rates, and the current lease rate, based on the amount of the gold lending rights already leased, is highlighted in bold for its remaining gold lending rights inventory.

At Block D, ACME chooses which banks and investment banks through which its gold inventory lending rights may be leased, which helps preserve the anonymity of the commodity rights lessee from ACME.

At Block E, ACME then notes that different lease rates are available for terms shorter than the one-year terms noted, but that those lease rates may vary from the stated annual lease rates.

Finally, at Block F, ACME then accepts and saves it borrowing terms or can choose to edit them.

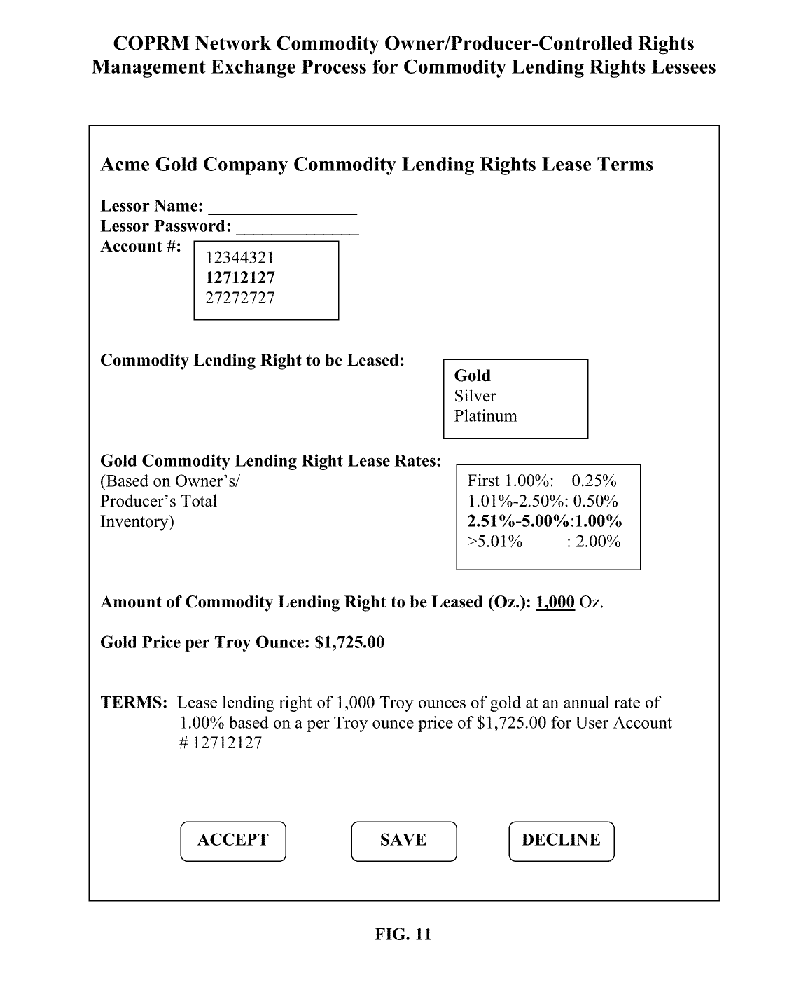

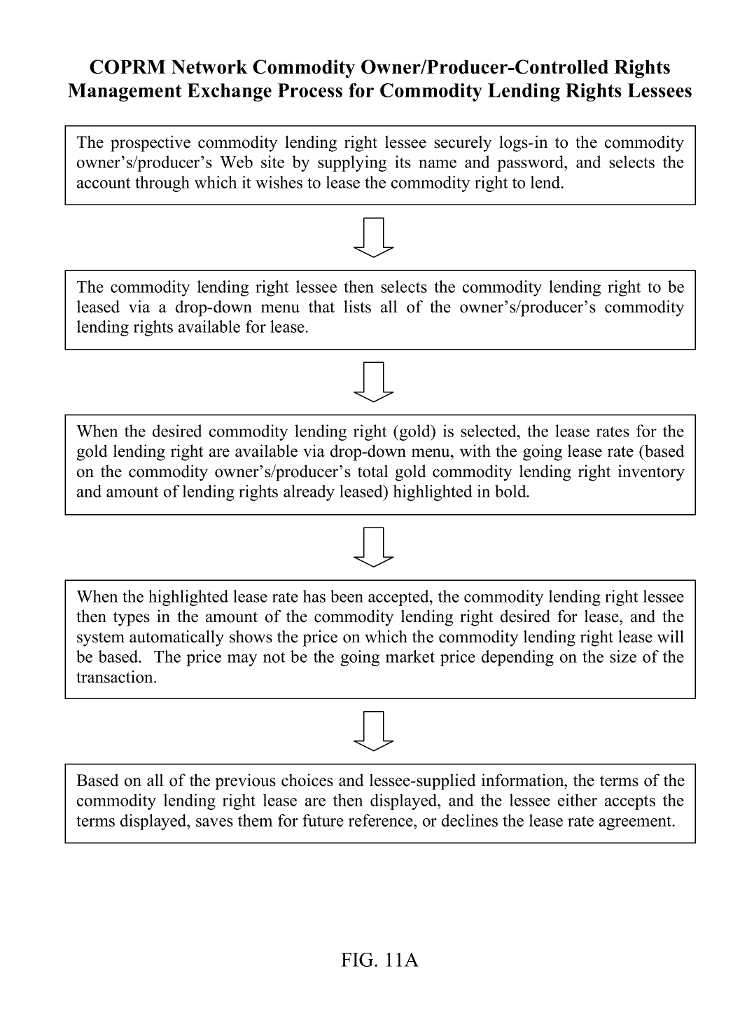

FIG. 11 shows the an exemplary graphical user interface (GIU) screen for the COPRM Network Commodity Owner/Producer-Controlled Rights Management Exchange Process for Commodity Lending Rights Lessees, through which a commodity lessee accesses the commodity owner's/producer's Web site to initiate the commodity lending rights lease process.

The prospective commodity lending right(s) lessee securely logs-in to the site and then selects, via drop-down menu, from various accounts it has established with the commodity owner/producer. After specifying the account(s) with which it will lease the commodity right, the commodity lending right lessee then selects the commodity lending right(s) it wishes to lease, in this case the commodity owner's/producer's gold commodity lending right, from another drop-down menu.

Once the commodity lending right to be leased has been selected, the commodity lending right lessee is then shown, via drop-down menu, the terms at which it may lease the commodity owner's/producer's commodity lending right(s). This is based on the owner's/producer's entire gold commodity rights inventory and future production based upon proven reserves, and is shown as an escalating lease scale, where the first 1.00% of the commodity owner's/producer's gold commodity right inventory may be borrowed at 0.25% per annum, the next 1.01-2.50% at 0.50% per annum, the next 2.51-5.00% at 1.00% per annum and anything above 5.00% of the commodity owner's/producer's commodity lending right inventory may be borrowed at 2.00% per annum.

The commodity lending right lessee then types in the commodity lending right amount, in ounces, it wishes to lease, and the system produces the real-time market price per Troy ounce for gold along with a summary of the terms at which the commodity lending right lessee may lease the gold commodity lending right from the commodity owner/producer.

The commodity lending right lessee then selects, from three buttons at the bottom of the screen, whether to accept the terms of the commodity owner/producer, save them for future reference, or decline them.

FIG. 11A is a flow chart depicting the various steps carried out during the COPRM Network Commodity Owner/Producer-Controlled Rights Management Exchange Process for Commodity Lending Rights Lessees on a graphical user interface (GUI) screen.

At Block A, the commodity lending right lessee securely logs-in to the commodity owner's/producer's Web site by supplying its name and password, and selects the account through which it wishes to lease the commodity owner's/producer's commodity right(s) to lend.

At Block B, the commodity lending right lessee then selects the commodity lending right(s) to be leased via a drop-down menu that lists all of the commodity owner's/producer's commodity lending rights available for lease.

At Block C, when the desired commodity lending right (gold) is selected, the lease rates for the gold commodity right lending rate are available via drop-down menu, with the going lease rate (based on the commodity owner's/producer's total inventory and amount of lending rights already leased) highlighted in bold.

At Block D, when the highlighted lease rate has been accepted, the commodity lending right lessee then types in the amount of the commodity lending right desired for lease, and the system automatically shows the price on which the commodity lending right lease will be based. The price may not be the going market price depending on the size of the transaction.

At Block E, based on all of the previous choices and lessee-supplied information, the terms of the commodity lending right lease are then displayed, and the lessee either accepts the terms displayed, saves them for future reference, or declines the lease rate agreement.

Also, it is understood that the illustrative embodiments may be modified in a variety of ways which will become readily apparent to those skilled in the art of having the benefit of the novel teachings disclosed herein. All such modifications and variations of the illustrative embodiments thereof shall be deemed to be within the scope and spirit of the present invention as defined by the Claims to Invention appended hereto.

1. A system for implementing a commodity owner/producer rights management process (COPRMP) over a distributed communications network, and deployed in a financial marketplace involving one or more commodity owners/producers, one or more commodity purchasers, one or more commodity borrowers, said system comprising:
a data center, including one or more relational database servers (RDBMS), application servers, and web servers, interfaced with the infrastructure of said distributed communications network;
a first networked group of computer systems for use by said one or more said commodity owners/producers, and being interfaced with the infrastructure of said distributed communications network, and including client machines and server machines, for supporting packet-based communications between said data center and said first networked group of computer systems;
a second networked group of computer systems for use by said one or more commodity borrowers, and being interfaced with the infrastructure of said distributed communications network, and including client machines and server machines, for supporting packet-based communications between said data center and said second networked group of computer systems;
wherein said data center supports the implementation of a network-level financial accounting system that recognizes and accounts for a set of commodity rights possessed by said commodity owner/producer of commodities prior to commodity production/sale, and ensures that said set of commodity rights is unbundled, separated into a plurality of individual commodity rights (CR (α . . . n, $)), including the commodity right to lend (CR (ξ, $)), and recombined into non-borrowable commodities (commodity rights packages) that exclude the commodity right to lend (CR (ξ, $)) and/or other commodity rights, which are offered for sale or lease in said financial marketplace; and
wherein said commodity owner/producer of a commodity owned or produced in said financial marketplace (i) withholds from, and prior to, commodity production/sale/lease, the commodity right to lend (CR (ξ, $)) (and/or other commodity rights), to create said non-borrowable commodity right(s) package, which precludes lending and borrowing of said non-borrowable commodity by said purchasers and/or lessees of said non-borrowable commodity and, which, can be borrowed only from said commodity owner/producer holding said commodity right to lend (CR (ξ, $)) by purchasing or leasing said commodity right to lend at sale/lease rates set by said commodity owner/producer, thereby precluding the lending of said non-borrowable commodity by said commodity purchasers/lessees in said financial marketplace;
wherein said commodity owner/producer uses said first networked group of computer systems to communicate with said data center via packet-based communications, to set sale and/or lease rates and periods for said commodity right to lend (CR (ξ, $)) associated with said non-borrowable commodity (commodity rights package) held by said commodity purchasers/lessees, and which can be bought or leased by commodity rights package purchasers/lessees, or by other market participants, from said commodity owner/producer only after procuring the commodity right to lend (CR (ξ, $)), through sale or lease, from said commodity owner/producer pursuant to agreement with said purchase or lease rates and periods;
wherein said commodity purchasers or lessees, or other market participants, use said second networked group of computer systems to communicate with said data center via packet communications, and (i) requests from said commodity owner/producer, the commodity right to lend (CR (ξ, $)) for said non-borrowable commodity pursuant to said borrowing rates and periods set by said commodity owner/producer, (ii) accepts said borrowing rates and periods set by said commodity owner/producer, and (iii) receives said commodity right to lend (CR (ξ, $)) associated with said non-borrowable commodity, from said commodity owner/producer, via said data center, so that said commodity borrower can borrow said non-borrowable commodity from said commodity owner/producer for the purpose of selling said non-borrowable commodity short in said financial marketplace; and
wherein said data center automatically accounts for the allocation of said borrowed commodity right to lend (CR (ξ, $)) associated with said non-borrowable commodity, and payment of said borrowing rates agreed to between said commodity owner/producer and said commodity borrower.

2. The system of claim 1, wherein each said first and second group of networked computer systems comprises relational database servers (RDBMSs), application servers, and web servers, and client machines supporting graphical user interfaces (GUIs).

3. The system of claim 1, wherein said distributed communications network comprises the Internet supporting TCP/IP.

4. The system of claim 1, wherein said commodity owner/producer comprises one or more commodity owners and/or producers.

5. The system of claim 1, wherein owners/producers of commodities are afforded the opportunity to withhold, control and transfer (temporarily or permanently) the commodity right to lend (CR (ξ, $)), which they possess prior to commodity production/sale/lease, so as to optimize profit from, and to manage, the lending/borrowing and, thus, short-selling of their commodities.

6. The system of claim 1, wherein commodity owners/producers are afforded the opportunity to collect commodity borrowing revenue from short-term or high-frequency traders, by requiring all commodity borrowing to be sourced through the commodity owners/producers that have withheld the commodity right to lend ((CR (ξ, $), or through purchasers/lessees/holders of said commodity right to lend, which facilitates immediate location and borrowing of said commodities.

7. The system of claim 1, which further comprises a third networked group of computer systems for use by government regulatory agencies, and being interfaced with the infrastructure of said distributed communications network, and including client machines and server machines, for supporting communications between said data center and said third networked group of computer systems; and wherein said government regulatory agencies use said third networked group of computer systems to communicate with said data center via packet-based communications, for the purpose of overseeing said commodity owners/producers and said commodity borrowers in said financial marketplace.

8. The system of claim 1, wherein commodity owners/producers are able to withhold, prior to production or sale, the individual right to lend commodities ((CR (ξ, $), so as to preclude borrowing and, thus, short-selling of said commodities.

9. The system of claim 1, wherein said commodity owners/producers (or subsequent commodity buyers) are able to restructure existing, outstanding commodities to withhold the individual commodity right to lend commodities ((CR (ξ, $), so as to preclude borrowing and, thus, short-selling of their commodities.

10. The system of claim 1, whereby a long-only commodity is created by a commodity owner/producer by permanently withholding the commodity right to lend ((CR (ξ, $) prior to the production/sale of a commodity.

11. The system of claim 1 whereby a commodity owner/producer (or subsequent commodity buyer) establishes the sale and leasing rates for the commodity right to lend ((CR (ξ, $) using either flat rate(s), commodity consumption cycle, commodity futures expiration dates, average commodity life cycle, or other commodity-related metrics.

12. A computer network-implemented system that allows the commodity owner/producer to retain the right (authority and power) to lend a commodity prior to, and after, sale of the commodity, and allows commodity borrowers to request from the commodity owner/producer, through the system, the right to borrow the non-borrowable commodity from the commodity owner/producer for the purpose of selling the non-borrowable commodity short in the financial/commodity marketplace and profiting from a short sale, without damaging the commodity owner's/producer's ongoing economic interests.
